(19) United States
(12) Patent Application Publication
(10) Pub. No.: US 2007/0135601 A1
(43) Pub. Date: Jun. 14, 2007

(54) Initiator systems for polymerisable compositions

(75) Inventors: Constantinos D. Diakoumakos, Cambridge (GB); Dimiter Lubomirov Kotzev, Northants (GB)

Correspondence Address: Huntsman Corporation;Legal Department, 10003 Woodloch Forest Drive, The Woodlands, TX, 77380, US

(73) Assignee: Huntsman Advanced Materials Americas Inc., Salt Lake City, UT (US)

(21) Appl. No.: 10/578,731

(22) PCT Filed: Nov. 10, 2004
(86) PCT No.: PCT/EP04/52898

§ 371 Date: May 10, 2006

(30) Foreign Application Priority Data
Nov. 11, 2003 (GB) 0326286.2

(51) Int. Cl. C07F 7/02

(52) U.S. Cl. 526/195; 526/196; 548/955; 556/402

(57) ABSTRACT

The present invention relates to complexes of organoboranes with amino functional organosilicon compounds which are effective polymerisation initiators for radically polymerisable systems, especially acrylate or methacrylate adhesives. The complexes are partcularly useful in the preparation of adhesives for bonding low surface energy plastics based on, for example, polyolefins and polyfluoroolefins.

The present invention relates to complexes of organoboranes with amino functional organosilicon compounds which are effective polymerisation initiators for radically polymerisable systems, especially acrylate or methacrylate adhesives. The complexes are particularly useful in the preparation of adhesives for bonding low surface energy plastics based on, for example, polyolefins and polyfluoroolefins.

Low surface energy polyolefins such as polyethylene, polypropylene and polytetrafluoroethylene have a variety of attractive properties in a variety of uses. However, because of the low surface energy of these plastic materials, it is very difficult (a detailed description of the difficulties in adhesively bonding these materials can be found in “Adhesion Problems at Polymer Surfaces” by D. M. Brewis, appeared in “Progress in Rubber and Plastic Technology”, vol. 1, p.1, 1985) to find adhesive compositions, which bond to them. The commercially available adhesives, which are used for these plastics generally, require complex and costly substrate surface pretreatment of the surface before the adhesive will bond to the surface. Such pretreatments include corona discharge, flame treatment, plasma treatment, oxidation by ozone or oxidizing agents, sputter etching and the like. Another approach for adhesively bonding low surface energy substrates is via coating the low surface energy substrate with a material of high surface energy. But, also in this case the low surface energy substrates need to be previously pretreated with one of the aforementioned surface preparation techniques in order to assure adequate adhesion of the primer. All of these techniques can be found in “Treatise on Adhesion and Adhesives” by J. D. Minford, Marcel Dekker, 1991, New York, vol.7, p.333-345). There is therefore a need for adhesive compositions, which are capable of bonding to low surface energy substrates, and bonding low surface energy substrates to other substrates, without the need for extensive or costly surface preparation techniques.

There is considerable prior investigation into use of organoboron compounds, including bonding surfaces of low surface energies. Eg G. Kolesnikov and L. Fedorova [Bull. Acad. Sci. USSR, Div. Chem. Sci. p. 236 (1957)] report on the polymerization of acrylonitrile in the presence of tributylborine.

U.S. Pat. No. 5,376,746, U.S. Pat. No. 5,286,821 and U.S. Pat. No. 5,143,884 relate to a two-part initiator system useful in adhesive compositions comprising in one part a stable organoborane/amine complex and in the second part an aldehyde destabilizer or activator. This initiator is particularly useful in elastomeric acrylic adhesive compositions and provides room temperature, relatively slow curing systems with good adhesive properties making them useful in applications where longer open times are required.

U.S. Pat. No. 5,310,835 and U.S. Pat. No. 5,106,928 describe a two-part initiator system useful in adhesive compositions comprising in one part a polymerizable acrylic monomers and an organoborane/amine complex and in the second part an organic acid destabilizer and optional acrylic polymer.

U.S. Pat. No. 5,690,780 and US 2002/0028894 disclose polymerizable acrylic compositions which are particularly useful as adhesives wherein specific organoborane/amine complexes are used to initiate cure.

U.S. Pat. No. 5,795,657 relate to organoborane/amine complexes comprising organoboranes and polyamines. The polyamine is the reaction product of a diprimary amine-terminated material and a material having at least two groups reactive with primary amine. The complexes are useful in systems for initiating the polymerization of acrylic monomers which systems further include a material reactive with the amine. Polymerizable acrylic monomer compositions useful in adhesive applications are also provided.

U.S. Pat. No. 5,935,711 describe compositions comprising organoborane/amine complexes and aziridine-functional material to form polymerization initiator systems in acrylic-based polymerizable compositions useful in adhesive compositions for bonding low surface energy substrates.

U.S. Pat. No. 5,952,409 discloses stain blocking compositions comprising a stain blocking material and an organoborane/amine complex.

U.S. Pat. No. 5,990,036 and U.S. Pat. No. 5,872,197 relate to systems for initiating polymerization of acrylic monomers comprising organoborane/amine complexes and bireactive decomplexers preferably comprising at least one free-radically polymerizable group and at least one amine-reactive group in the same molecule. The decomplexer is capable of forming a covalent bond with both the acrylic monomers and amine complex, resulting in a reduced level of mobile constituents.

U.S. Pat. No. 6,027,813 and U.S. Pat. No. 5,883,208 describe systems for initiating the polymerization of acrylic monomers comprising organoborane/amine complexes and decomplexers comprising at least one anhydrate group. Adhesive compositions prepared from the initiator systems presented good adhesion on low surface energy substrates.

U.S. Pat. No. 6,093,778, U.S. Pat. No. 5,994,484 and U.S. Pat. No. 6,008,308 disclose compositions comprising organoborane/amine complexes and polyols. The compositions can form a part of a polymerization initiator system that also includes polyisocyanate. The system can be used to initiate polymerization of acrylic monomer and to form a polyurethane/polyurea acrylic adhesive that has good adhesion to low surface energy substrates.

U.S. Pat. No. 6,252,023 and WO 00/56779 relate to compositions comprising an organoborane/amine complex and 1,4-dioxo-2-butene functional material. The compositions can form a part of a polymerization initiator system that also includes a compound that is reactive with the amine position of the complex. The system can be used to initiate polymerization of acrylic monomer and to form an acrylic adhesive that exhibits good adhesion to low surface energy substrates.

U.S. Pat. No. 6,248,846 describes polymerizable acrylic compositions comprising of at least one acrylic monomer, an effective amount of organoborane/amine complex and an effective amount of an acid for initiating polymerization of the acrylic monomer. The polymerizable acrylic compositions are useful for bonding low surface energy substrates.

US 2002/0028894 and US 2002/0033227 disclose a method polymerization and bonding two or more substrates together that comprises contacting the components of a composition comprising an organoborane/amine complex, one or more of monomers, oligomers, or polymers having olefinic unsaturation and optionally an effective amount of a compound which causes th complex to disassociate or heating the composition to a temperature at which the complex disassociates.

US 2002/0031607 relates to a method of modifying the surface of a low surface energy polymer by contacting the surface with a composition comprising an organoborane/amine complex, one or more of monomers, oligomers, or polymers having olefinic unsaturation and optionally an effective amount of a compound which causes th complex to disassociate or heating the composition to a temperature at which the complex disassociates.

WO 99/64475 describes initiator systems including both a complexed initiator (organoborane/amine complex) and a carboxylic acid decomplexer. Dicarboxylic acid, carboxylic acid esters, and monocarboxylic acid (preferably those comprising an alkyl group having at least nine carbon atoms fro low odor compositions) are useful as decomplexers in polymerizable compositions.

WO 99/64528 discloses low odor polymerizable compositions. The polymerizable compositions are useful in kits also comprising an aerobic initiator Also disclosed are bonding compositions, polymerized compositions, coated substrates and methods of bonding in which the polymerizable compositions are especially useful.

WO 01/32716 relates to initiator systems compromising a complexed initiator comprising at least one of a complex of a complexing agent comprising at least one hydroxide (e.g. organoborane hydroxide complex) and an initiator or a complex of a complexing agent comprising at least one alkoxide (e.g. organoborane alkoxide complex) and an initiator or mixtures or combinations thereof; and a decomplexer.

WO 01/44311 describes an amine-organoborane complex wherein the organoborane is a trialkyl borane and the amine is an amine having an amidine structural component; an aliphatic heterocycle having at least one nitrogen in the heterocyclic ring wherein the heterocyclic compound may also contain one or more nitrogen atoms, oxygen atoms, sulfur atoms, or double bonds in the heterocycle; a primary amine which in addition has one or more hydrogen bond accepting group wherein there is at least two carbon atoms, preferably three, between the primary amine and the hydrogen bond accepting group, such that due to inter- or intramolecular interactions within the complex the strength of the B—N bond is increased; or a conjugated imine. Preferred hydrogen bond accepting groups include the following: a secondary amine, a tertiary amine, an ether, a halogen, a polyether group or a polyamine group. The complexes of the invention are used in polymerizable compositions, adhesive compositions and coatings compositions containing compounds having moieties which polymerize under free radical polymerization conditions.

WO 02/34851 discloses the use of specific quaternary boron salts as initiators in polymerizable compositions and uses thereof for bonding low surface energy substrates.

WO 02/34852 relates to the use of metal alkyl borohydrides as initiators of polymerization, particularly in adhesive compositions for bonding a wide range of substrates including low surface energy substrates such as polyolefins. In particular, alkali metal trialkyl borohydrides are used, the alkali metal salt being selected from: lithium triethylborohydride, sodium triethylborohydride, potassium triethylborohydride, lithium tri-sec-butylborohydride, sodium tri-sec-butylborohydride, potassium tri-sec-butylborohydride and lithium triethylborodeuteride and others less effective on low surface energy substrates such as lithium 9-borabicyclo [3.3.1]-nonane (9BBN) hydride, lithium thexylborohydride, lithium trisiamylborohydride and potassium trisiamylborohydride.

WO 03/035703 and WO 98/17694 describe (meth)acrylate based polymerizable compositions and adhesive systems prepared therefrom which include an aziridine-containing compound in a carrier material (diluent). The inventive compositions and adhesive systems are particularly well suited to bonding applications, which involve at least the bonding of one low energy surface (e.g. polyolefin, polyethylene, polypropylene, etc.).

WO 03/038006 discloses a two part composition for initiating cure of one or more polymerizable monomers which cure when exposed to free radicals comprising in one part an organoborane/amine complex and in the second part an isocyanate which is capable of decomplexing the organoborane complex wherein the ratio of amine nitrogen atoms to boron atoms is grater than 4.0:1.0.

WO 03/040151 relates to the use of internally blocked organoborates as initiators for free-radically polymerizable compositions useful in adhesive compositions.

WO 03/057791 describes metal salt modifiers for two-part bonding compositions useful in bonding low surface energy substrates. The metal salt modifiers modify the curing kinetics of the bonding composition.

U.S. Pat. No. 4,538,920 disclose a multiple-barreled resin-dispensing device having a syringe, an exit conduit, a static mixing element, means for detachably coupling the inlet of the exit conduit to the outlet end of the syringe, and means for locating the static mixing element within the exit conduit to provide rotational alignment of the static mixing element relative to the syringe.

U.S. Pat. No. 5,082,147 relates to an applicator that delivers from side by side chambers a two-part urethane polymer composition in which the diisocyanate is differentially reactive with two amine components of side B such that an initial, faster reaction with one amine keeps viscosity low while a second, slower reaction with the second amine builds viscosity to a self-supporting paste outside the applicator.

U.S. Pat. No.6,777,512 published Aug. 17, 2004, describes a polymerizable composition for adhesive composition for bonding substrates which comprises organoborane amine complex, olefinically unsaturated compounds, and polymerization catalyst for compounds having siloxane backbone.

However, many problems remain, particularly regarding cure rate, adhesive bond strength and composition stability. There remains an unmet need for stable adhesive compositions, which are capable of bonding low surface energy substrates. In particular, there remains the need for initiator systems for free radical polymerization which are safe to handle, are stable, and which can be used to cure polymerisable systems on-demand.

The present invention provides a complex of an organoboron compound of the general formula
B(R¹)3 (1)
in which each R′ independently represents an alkyl, aryl, alkylaryl, arylalkyl, cycloalkyl, alkylcycloalkyl or cycloalkylalkyl group which may be unsubstituted or substituted by one or more of the same or different substituents selected from halogen atoms and alkoxy groups; with an organosilicon compound containing at least one primary, secondary and/or tertiary amino group.

Preferably an alkyl or alkoxy group present in R¹ has from 1 to 10, preferably 1 to 6, especially 1 to 4, carbon atoms, and preferably any aryl moiety is a phenyl group. A cycloalkyl moiety preferably has from 5 to 7 carbon atoms. Preferred halogen atoms are chlorine and fluorine atoms.

Preferably each R¹ independently represents a C₁₋₄ alkyl group. Preferably the compound of formula I is tri-n-butylborane, tri-t-butylborane, triisopropylborane or triethylborane. Tributylborane is less preferred as it may give lower cure rate. Most preferred are triisopropyborane and triethylborane especially triethylborane.

The organosilicon compound may be based on a silane, silicone, silica gel, silazane, silatrane or silsesquioxane. Particularly suitable compounds may be represented by the following general formulae II: 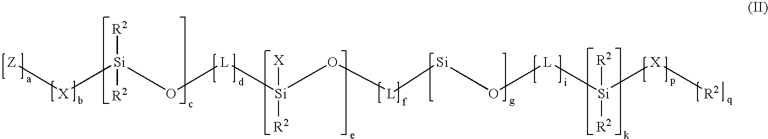
in which:
a, q, are independently equal to 0 or 1;
b, c, d, e, f, g, i, k, p, are independently equal to or higher than 0;
(a, c, e, g, k, cannot be all equal to 0 at the same time. At least one of them should be higher than 0 and at least one of the b, d, f, i, p should be equal to or higher than 1).
each R² independently represents a hydrogen atom or a hydroxyl group or an alkyl (e.g. isopropyl, isobutyl, isooctyl, propylisobutyl, etc.), halogen alkyl, glycidyl alkyl, acrylalkyl, (meth)acrylalkyl, alkoxy, alkoxyalkyl, alkenyl, cycloalkyl (e.g. cyclohexyl, propylcyclohexyl, etc.), aryl, alkyloxyaryl, aryloxyalkyl or alkyloxycycloalkyl group, each of which may be optionally substituted by one or more primary, secondary or tertiary amino groups and/or other functional groups such as hydroxyls, carbonyls; and

each X (which can be monovalent or divalent depending on the values of a, c, d, e, f, g, i, k, and q) independently represents a group of the general formulae (III) and (IV):

| monovalent X | divalent X |
|---|---|
| 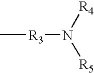 | 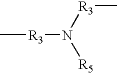 |
| (IIIa) | (IIId) |
| 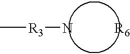 | |
| (IIIb) | |
| 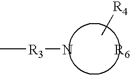 | 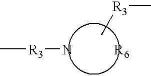 |
| (IIIc) | (IIIe) |
| 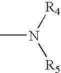 | 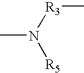 |
| (IVa) | (IVd) |
| 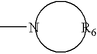 | |
| (IVb) | |
| 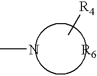 | 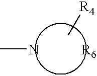 |
| (IVc) | (IVe) |
| | 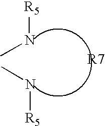 |
| | (IVf) |

in which R³ represents an alkylene, alkenyl, phenylene or cycloalkylene group; and each of R⁴ and R⁵ independently represents a hydrogen atom, a hydroxyl group, or an alkyl, aryl, silylalkyl, silylaryl, cycloalkyl, arylalkyl, alkylaryl, cycloalkylalkyl, alkylcycloalkyl, eterocyclic (saturated or unsaturated), phenyl (Ph-), phenoxy (Ph-O—), or Ph-(C═O)- group each of which may be optionally substituted by one or more primary, secondary or tertiary amino groups and/or other functional groups such as hydroxyls, carbonyls, etc., R⁴and R⁵ can independently be also R², R⁶ can be a “cyclic” group that means a closed ring hydrocarbon group that is classified as an alicyclic group, aromatic group, or eterocyclic (saturated or unsaturated) group and each one of them can be mono-, di-, tri-, tetra-, penta-substituted by R³ or R⁴ groups (structures IIIc, IIIe, IVc and IVe described only the mono-substituted derivatives). X can also contain organic groups or organic linking groups can include heteroatoms (e.g. O, S, Si atoms) such as in the case of heterocyclic compounds as well as functional groups (e.g. carbonyl, hydroxyl groups, etc).

R⁷ can be a “cyclic” of the structure —Si(R²)[—Si(R²)₂—NH—]ₙ—Si(R²)—, where n is equal to or higher than 1.

in which L represents:

A monovalent or divalent (depending on the values of the a, b, c, e, g, k, p and q) group and can be independently selected from any of the groups representing the X group or it can also be R² or R³ or R⁵ or R⁴ or R⁶ or R⁷ or any polymeric/oligomeric organic mono- or di-radical.
in which Z represents: 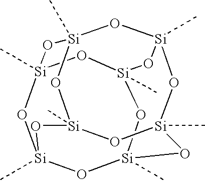
where every silicon atom forms a bond (represented by the dashed lines on the above drawing) with either X or R² or R⁴ or R⁵ and at least one silicon atom must be bonded with one X.

Preferably the amino group of the complex is a primary or a secondary amino groups. With tertiary amino groups it may be more difficult to form the complex if at all.

In the organosilicon compound, and elsewhere throughout this specification and claims except where otherwise stated, any alkyl moiety preferably has 1 to 10, preferably 1 to 6, and most preferably 1 to 4 carbon atoms; an alkyl moiety may for example be a methyl group; any aryl group is preferably a phenyl group; and any cycloalkyl group preferably has from 5 to 8 carbon atoms.

High molecular weight silicon compounds may be used, for example compounds having a molecular weight up to 6,000,000. In high molecular weight compounds, m plus n may for example be up to 70,000.

Typically the organosilicon compound may have the formula derived from the general formula II for b=1, c=1, q=1 and a, d, e, f, g, i, k, p, q are all independently equal to 0 and where X and R² groups are as defined here before.

Typically the organosilicon compound may have the formula derived from the general formula II for b=1, c>1, e>1, k=1, p=1 and a, d, f, g, i, q are all independently equal to 0 and where X and R² groups are as defined here before.

Typically the organosilicon compound may have the formula derived from the general formula II for a=1, b=1 and c, d, e, f, g, i, k, p, q are all independently equal to 0 and where X group is as defined here before.

One preferred group of silicon compounds described by the general formula II, are silanes, which contain primary or secondary or tertiary amino groups or combinations thereof. Examples of suitable silanes are represented by the following formulae:

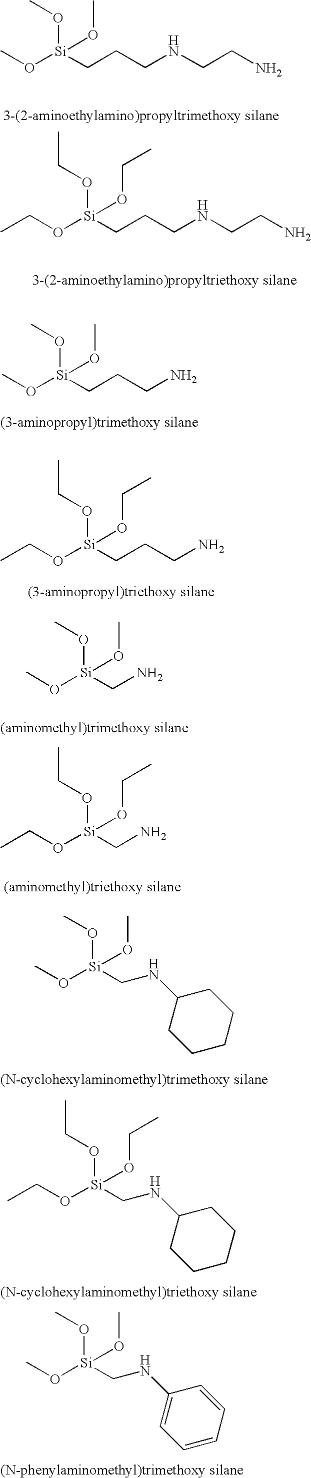

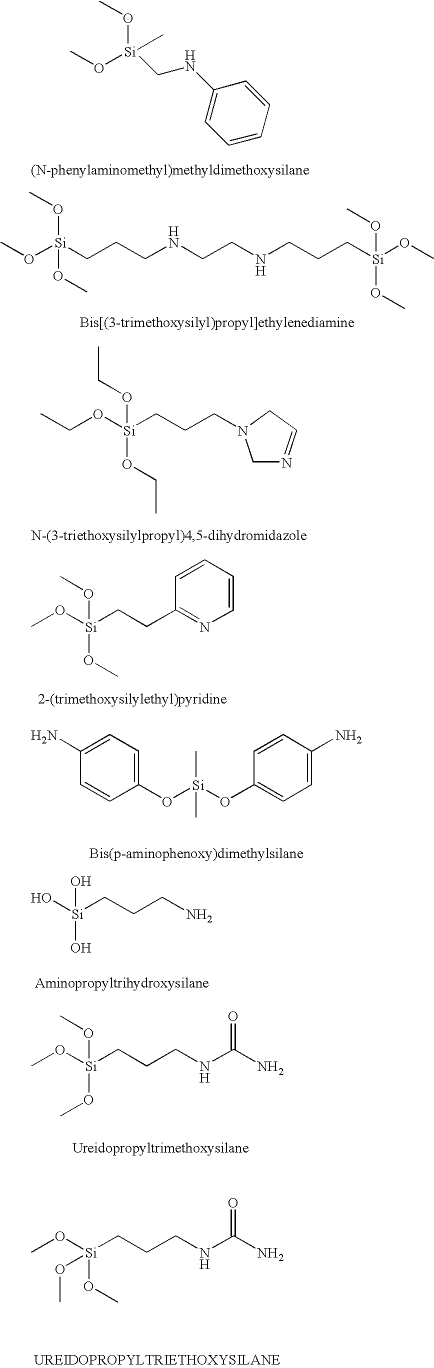

Other compounds that are described by the general formula II are:

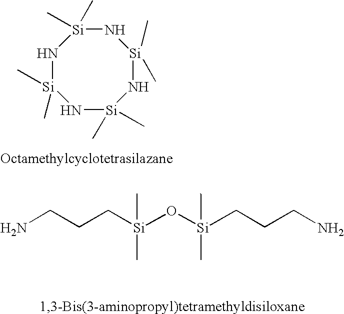

The organosilicon compound of the general formula (II) may be an organofunctional silicone fluid. Such compounds may be represented by the following formula, which may contain one or more organic groups X in the positions shown: 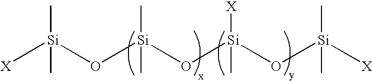
in which x and y are integers.

The organosilicon compound of the general formula (II) may be an organofunctional silica gel. Such compounds may be represented by the following formula. 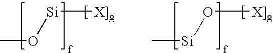
in which f and g are each one higher than 0.

Alternatively, the organosilicon compound may be a so-called Polyhedral Oligomeric Polysilsesquioxane (POSS) bearing at least one organic group X. POSS materials are classified as nanostructured chemicals, and are the smallest particles of silica possible. However, unlike silica, silicones, or fillers, each POSS molecule contains non-reactive organic functionalities for solubility and compatibilization of the POSS nanostructure with polymers, biological systems, and surfaces. In addition, POSS nanostructured chemicals can contain one or more covalently bonded reactive functionalities suitable for polymerization, grafting, surface bonding, or other transformations. Typical generic chemical structure is as follows: 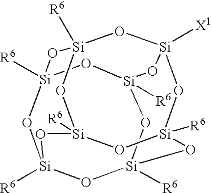
where the X¹ is the same as X; R⁶ is the same as R² or R² or R⁴ or R⁵ or X.

Typical such compounds finding utility in the present invention include: 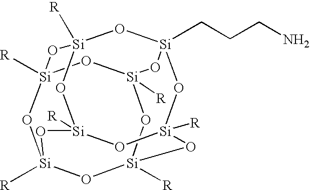
where “where R is alkyl, aminoalkyl, cycloalkyl, aryl, amine substituted cycloalkyl or amino group
and 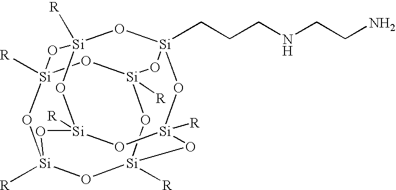
where R is alkyl, aminoalkyl, cycloalkyl, aryl, amine substituted cycloalkyl or arogroup.

A typical example of a silatrane compound is the following: 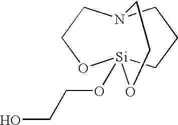
Hydroxyethoxysilatrane

Some specific amino-silicon compounds are:
1. N-(2-AMINOETHYL)-3-AMINOPROPYLSILANETRIOL 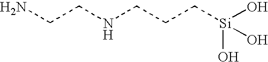
2. N-AMINOETHYL-AZA-2,2,4-TRIMETHYLSILACYCLOPENTANE CAS Number [18246-33-8]

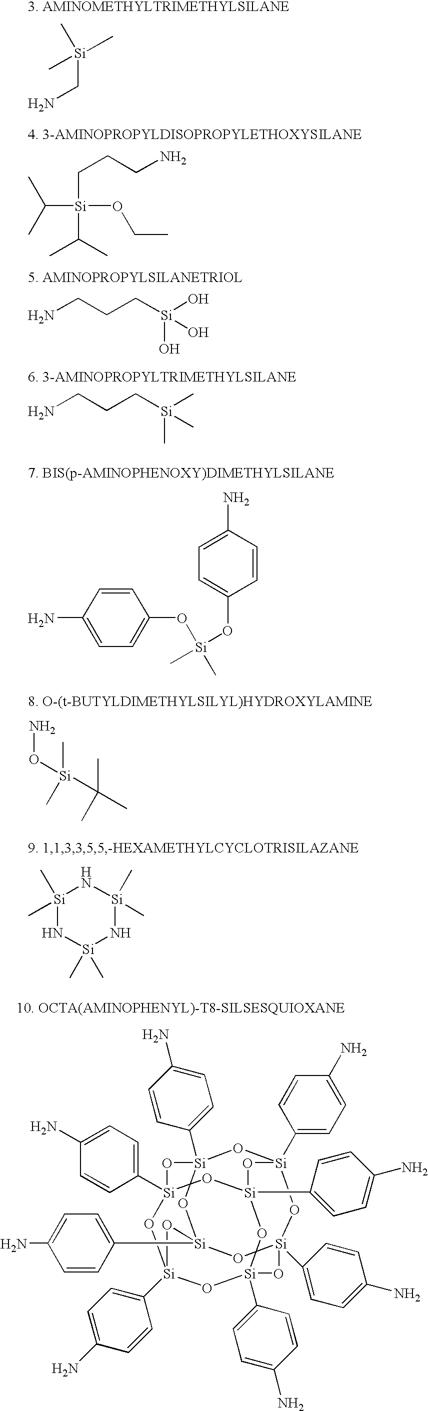

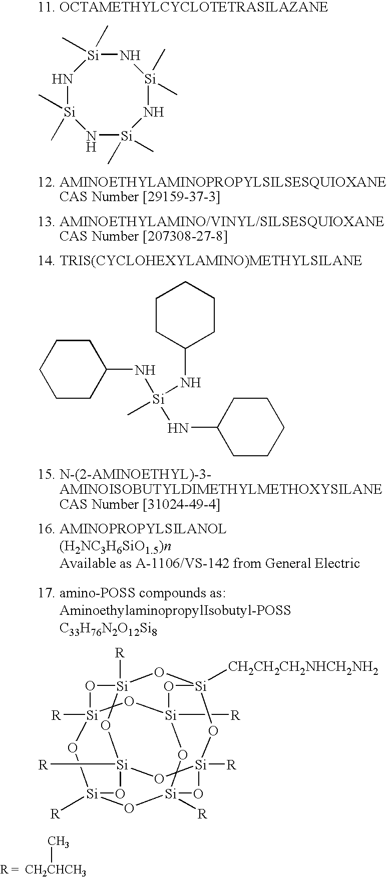

The compounds that can be used in forming complexes with substances of the general formula (I) may also be a mixture of at least two of the above-mentioned typical organosilicon compounds.

The complexes of the present invention may be prepared for example by contacting a solution of the organoborane compound of the general formula (I) with the organosilicon compounds of the general formula II, suitably under an inert atmosphere, with cooling if required.

In the complexes according to this invention the ratio of boron atom (organoborane) to nitrogen atom (complexing agent) can be as low as 0.01:1 (ratio B:N), preferably higher than 0.3:1 and most preferably 1:1. In certain of the complexing agents described by the general formula II, this ratio can be higher than 1:1 (e.g. 3:1, 7:1, 10:1, 21:1, etc.) depending on the molecular weight of the these complexing agents. The higher the molecular weight, the more this ratio can deviate from the 1:1 towards higher number of boron atoms to 1 nitrogen atom.

The complexes according to the-present invention-are-air stable and can be utilized as polymerisation initiators for radically polymerisable monomers or oligomers, and accordingly the present invention provides a polymerisable composition which comprises a complex according to the invention and at least one radically polymerisable monomer and/or oligomer. Such compositions find application as, for example, paints, coatings, sealants, inks, primers, stain blocking compositions, mouldings and, especially, adhesives. Such materials, especially when used in adhesive applications, are commonly formulated as two-part products in which the two parts are mixed together as required to initiate curing. Accordingly, the invention also provides a two-part polymerisable composition, in which a first part comprises a complex according to the invention and a second part comprises at least one radically polymerisable monomer and/or oligomers. The invention further provides a method of adhesively bonding two substrates together, which comprises applying a polymerisable composition according to the invention (which may involve mixing together the two parts of a two part polymerisable composition) to a first substrate, positioning a second substrate (that may or may not be coated with the polymerizable product) in contact with the first substrate via said product, and allowing or causing the product to cure. Although substrates of surface energy higher than 40-45 mJ/m² can be bonded (e.g. stainless steel, iron, aluminium, copper, tin, lead, glass, polypropylene oxide, polyethersulfone, etc.), the invention is particularly useful for adhesively bonding together low surface energy substrates or in cross bonding a low surface energy substrate with different substrates (e.g. metals). Thus, preferably at least one substrate is a low surface energy substrate. A low surface energy substrate generally has a surface energy of less than 50 mJ/m², less than 40 mJ/m² or even less than 35 mJ/m². Included among the recognized low surface energy substrates are materials like polyethylene, polypropylene, copolymers of a-olefins, and fluorinated polymers such as polytetrafluoroethylene. Other polymers that can be bonded include polycarbonate, poly(methyl methacrylate), acrylonitrile-butadiene-styrene as well as other polymers and plastics with higher surface energy. However the invention is not limited to bonding of low surface energy materials. The compositions may be used to bond any thermoplastics, thermosets as well as wood, composites, ceramics, glass, concrete, and metals.

The invention further provides the use of a complex according to the invention as an initiator for the polymerisation of a radically polymerisable monomer or oligomer.

Preferably the second part of a two-part polymerisable composition according to the invention also includes a decomplexing agent capable of releasing the organoborane compound from the complex such that, on mixing of the two parts, the decomplexing agent reacts with the organosilicon-based organoborane compound, liberating as a result the organoborane compound. The organoborane compound in turn initiates polymerisation. Any compound capable of releasing the boron compound from the complex may be used as decomplexing agent. Examples of such compounds can be found in WO 99/64475, WO 00/56779. Preferable examples include acids (Lewis acids i.e. SnCl₄, TiCl₄ and the like, Brönsted acids [e.g. mono- or poly-carboxylic acids saturated or unsaturated], HCl, H₂SO4, H₃PO₄, phosphonic acid, phosphinic acid, silicic acid and the like), mono- or poly-carboxylic acid esters (saturated or unsaturated), anhydrides, isocyanates, cyclocarbonates, aldehydes, acid chlorides, sulphonyl chlorides, and epoxies. Particularly favourable are decomplexers based on multi-functional aldehydes, containing more than one aldehyde group, eg terephthaloyl dicarbaxaldehyde.

The decomplexing agent according to the present investigation is employed in an effective amount and can also be a mixture of at least two decomplexers; that is an amount effective to promote polymerization by liberating organoborane from the complex, but without materially adversely affecting the properties of the ultimate polymerized composition. If larger amounts of these decomplexers are employed, this may speed-up polymerization in such an extend that in the case of adhesives, the resulting materials may demonstrate inadequate adhesion to low surface energy surfaces. However, a reduced amount of these decomplexers may be helpful in slowing down the rate of polymerization if it is otherwise fast. Within these parameters, the ratio of the equivalents of the decomplexer to those of the organoborane can be from 0.01 to 5:1 (ratio decomplexer: organoborane), more preferably from 0.05 to 4:1 and most preferably from 0.1:1 to 2:1.

Vinylic compounds, as alkenyl or styrenic compounds can function to extend the open time of the applied mixed composition. We have found the use of such open time extenders results in useful times of 10 minutes or greater handling time, in combination with the silicon amine organo-borane complexes of present invention, without compromising final full strength. Preferred such compound is 4-methylstyene [4-MS].

In an alternative embodiment, the polymerisation reaction may be initiated by supplying an appropriate form of energy to the system [the initiator (organoborane/organosilicon complex) may or may not be in a separate part to the polymerizable monomers] comprising the polymerisable composition, the energy being sufficient to release the boron compound from the complex. Suitably the energy is supplied by heating, or by the application of actinic radiation or by electromagnetic radiation or by magnetic radiation, electrical current, ultrasounds, ultraviolet radiation combinations thereof or any other means that result to the aforementioned specie of radiation or heat. This, in the case of adhesive formulations permits the development of one-component adhesives the curing of which can be triggered by any of the aforementioned energy sources.

The polymerization rate which is a crucial parameter for the effectiveness of the compositions described in this embodiment, can be tuned according to the type of the applicator i.e. a faster polymerization rate could be accommodated by using a high-speed automated industrial adhesive applicator whilst a lower polymerization may be desirable for applications where the adhesive needs to be applied either by a hand applicator or to be mixed manually. Preferably a composition according to the invention contains sufficient complex to provide 0.001 to 10% w, preferably 0.002 to 7.0% w, and most preferably 0.003 to 5.0% of boron, based on the total weight of the composition.

In another aspect of the present invention, the organoborane organosilicon compound complex can be used as a primer. In this case, a composition comprising a novel complex according to the invention is applied to the surface of a substrate, typically a low surface energy substrate. In a second step, a composition comprising a radically polymerisable monomer or oligomer is applied to the thus-primed surface, followed by application of a second substrate that is or is not similarly treated.

In yet another aspect, a composition comprising a complex according to the invention together with a radically polymerisable monomer or oligomer is applied to the surface of a substrate, typically a low surface energy substrate and left to cure, which renders the substrate bondable with conventional adhesives.

In another aspect, the newly prepared complexes can be used in stain blocking compositions comprising a stain blocking material as those described in essence in U.S. Pat. No. 5,952,409 (e.g. sulfonated aromatic polymers, polymers that are derived from at least one or more (a- and/or b-substituted) acrylic acid monomers and hydrolyzed copolymers of at least one or more ethyllenically unsaturated monomers and maleic anhydride, blends of at least two or more of these polymers, reaction products of at least two or more of the monomers from which these polymers may be derived and at least one or more of the polymers and materials obtained by polymerizing at least one or more of the monomers in the presence of one or more of the polymers, to mention some).

The compositions of the invention may also, if required, include a mixture of two or more organosilicon organoborane complexes in combination with a solvent and/or reactive or non-reactive diluent.

The polymerizable compositions of the invention may be used in a wide variety of ways, including as sealants, coatings, inks, primers, to modify the surface of polymers and injection molding resins. They may also be used as matrix resins in conjunction with glass and metal fiber mats such as in resin transfer molding operations. They may further be used as encapsulants and potting compounds such as in the manufacture of electrical components and printed circuit boards. Quite desirably, they provide polymerizable adhesive compositions that can bond a diverse myriad of substrates, including polymers, wood, ceramics, concrete, glass and metals. Another desirable related application is their use in promoting adhesion of paints to low surface energy substrates such as polyethylene, polypropylene, polyethyleneterephthalate and polytetrafluoroethylene and their co-polymers. In this embodiment the composition may be coated onto the surface of the substrate to modify the surface to enhance the adhesion of the final coating to the surface of the substrate or added to the coating itself.

The compositions of the invention can be used in coating applications. In such applications the composition may further comprise a diluent. The coating may further contain additives well known to those skilled in the art for the use in coatings such as pigments to color the coating, inhibitors and UV stabilizers. The compositions may also be applied as powder coatings and may contain the additives well known to those skilled in the art for use in powder coatings.

The compositions of the invention can also be used to modify the surface of a polymeric molded part, extruded film or contoured object. Compositions of the invention can also be used to change the functionality of a polymer particle/article by surface grafting of polymer chains onto the unmodified plastic surface.

Polymerizable Monomers/Oligomers

The invention is adapted to a variety of polymerizable compositions and includes any monomers, oligomers, polymers or mixtures thereof which contain olefinic unsaturation (characterized by the presence of a >C═C< group), which can be polymerized by free radical polymerization caused by the organoborane liberated from the organosilicone-based organoborane complex. Such compounds are well known in the art. U.S. Pat. No. 3,275,611, U.S. Pat. No. 5,690,780, U.S. Pat. No. 5,795,657, U.S. Pat. 5,872,197, U.S. Pat. No. 5,286,821, U.S. Pat. No. 5,681,910, WO 03/040151, WO 00/56779, WO 99/64475, WO 03/057791, to mention some as well as the literature (patents, papers, books, etc.) mentioned by them, provide a description of such compounds. Among preferred classes of compounds containing olefinic unsaturation are for example ethylene, propylene, butylenes, isobutylene, 1-octene, 1-dodecene, 1-heptadecene, 1-eicosene; vinyl compounds such as styrene, vinyl pyridine, 5-methyl-2-vinylpyridine, vinyl naphthylene, alpha methylstyrene; vinyl and vinylidiene halides; acrylonitrile and methacrylonitrile; vinyl acetate and vinyl propionate; vinyl oxyethanol; vinyl trimethylacetate; vinyl hexanoate; vinyl laurate; vinyl chloroacetate; vinyl stareate; methyl vinyl ketone; vinyl isobutyl ether; vinyl ethyl ether, compounds that have a plurality of ethylenic bonds such as those having conjugated double bonds such as butadiene, 2-chlorobutadiene and isoprene; acrylates and methacrylates such as methyl methacrylate, methyl acrylate, butyl methacrylate, t-butyl methacrylate, 2-ethylhexyacrylate, 2-ethylhexylmethacrylate, ethyl acrylate, isobornyl methacrylate, isobornyl acrylate, 2-hydroxyethyl methacrylate, glycidyl methacrylate, tetrahydrofurfuryl methacrylate, acrylamide, n-methyl acrylamide, and other similar acrylate or methacrylate containing monomers that can be mono and/or poly-functional and can contain apart from hydroxyl, amide and cyano groups, chloro and silane substituents. Also useful for the class of acrylate tipped polyurethane prepolymers available commercially from several sources and prepared by reacting an isocyanate reactive acrylate monomer, oligomer or polymer such as hydroxyl acrylate, with an isocyanate functional prepolymer.

Certain acrylic or methacrylic monomer combinations have been found to be particularly advantageous in providing polymerizable compositions having less odor. Such monomer combinations preferably comprise about 10-90% w/w on total weight of the monomer blend, tetrahydrofurfuryl methacrylate; 5-80% w/w on total weight of the monomer blend, of one or more monomers selected from the group consisting of 2-ethylhexyl methacrylate, 2-ethylhexyl methacrylate, 2-ethoxyethyl methacrylate, cyclohexyl methacrylate, isobornyl methacrylate, isooctyl acrylate and isooctyl methacrylate; and 0-70% w/w on total weight of the monomer blend, of one or more monomers selected from the group consisting of isobutyl methacrylate, n-butyl methacrylate, cyclohexyl methacrylate, cyclohexyl acrylate, n-hexyl methacrylate, isobornyl methacrylate, isodecyl methacrylate and isodecyl acrylate.

Another class of polymerizable monomers useful in the compositions of the present invention correspond to the following general formula 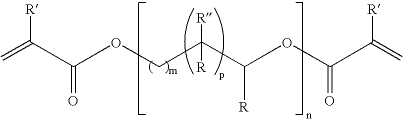
wherein R is selected from the group consisting of hydrogen methyl, ethyl, —CH₂OH, and 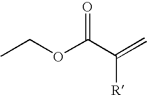
R′ is selected from the group consisting of chlorine, methyl and ethyl; R″ is selected from the group consisting of hydrogen, hydroxyl and 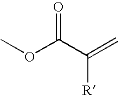
m is an integer equal to at least 1, e.g. from 1 to 8 or higher and preferably from 1 to 4 inclusive; n is an integer equal to at least 1, e.g. from 1 to 20 or more; and p is 0 or 1. Monomers that come within the above general formula include for example, ethylene glycol dimethacrylate, ethylene glycol diacrylates, polyethylene glycol diacrylates, tetraethylene glycol dimethacrylate, diglycerol diacrylates, diethylene glycol dimethacrylate, pentaerythritol triacrylate, trimethylpropane trimethacrylate and other polyether diacrylates and dimethacrylates. This class of materials is described in essence in U.S. Pat. No. 5,106,928 and U.S. Pat. No. 3,043,820.

Another class of polymerizable monomers useful in the present compositions corresponds to the following general formula: 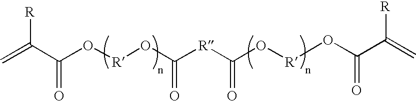
wherein R represents hydrogen, chlorine, methyl, or ethyl; R′ represents alkylene with 2-6 carbon atoms; and R″ represents (CH₂)ₘ in which m is an integer of from 0 to 8, or 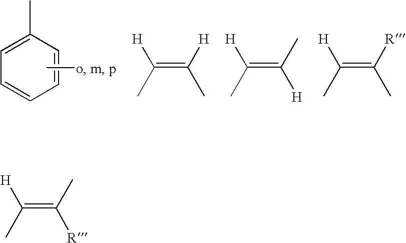
n represents an integer of from 1 to 4 and R′″ is methyl. Typical monomers of this class include, for example dimethylacrylate of bis(ethylene glycol) adipate, dimethylacrylate of bis(ethylene glycol)maleate, dimethylacrylate of bis(ethylene glycol) phthalate, dimethylacrylate of bis(tetraethylene glycol) phthalate, dimethylacrylate of bis(tetraethylene glycol) sebacate, dimethylacrylates of bis(tetraethylene glycol) maleate and the diacrylates and chloroacrylates corresponding to said dimethacrylates and the like. This class of polymerizable monomers are described in essence in U.S. Pat 5,106,928 and U.S. Pat. No. 3,457,212.

Another useful class of polymerizable monomers in the compositions of the present invention include monomers which are isocyanate-hydroxyacrylate or isocyanate-aminoacrylate reaction products which may be characterized as acrylate terminated polyurethanes and polyureides or polyureas. These monomers correspond to the following general formula: 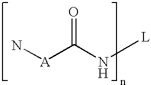
where A is selected from the group consisting of —O— and >N—R⁷, and R⁷ is a member selected from the group consisting of hydrogen and lower alkyl of 1 to 7 carbon atoms; N represents the organic residue of an active hydrogen containing acrylic ester wherein the active hydrogen has been removed, the ester being hydroxy or amino substituted on the alkyl portion thereof and the methyl, ethyl, and chlorine homologs thereof; n is an integer from 1 to 6 inclusive; L is a mono- or polyvalent organic radical selected from the group consisting of alkyl, alkylene, alkenyl, cycloalkyl, cycloalkylene, aryl, arylalkyl, alkylaryl, poly(oxyalkylene), poly(carboalkoxyalkylene) and heterocyclic radicals both substituted and unsubstituted. Typical monomers of this class include the reaction product of mono or poly-isocyanate, for example, toluene diisocyanate, with an acrylate ester containing a hydroxy or an amino group in the non-acrylate portion thereof, for example, hydroxyethyl methacrylate. The above class of monomers are described in essence in U.S. Pat. No. 5,106,928 and U.S. Pat. No. 3,426,988.

Another class of monomers useful herein are the mono- and poly-acrylate and methacrylate esters of bisphenol-type compounds many of which are widely available. These compounds can be described by the following formula: 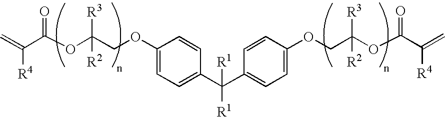
where R¹ is methyl, ethyl, carboxyalkyl or hydrogen; R² is hydrogen, methyl or ethyl; R³ is hydrogen, methyl or hydrogen; R⁴ is hydrogen, chlorine, methyl or ethyl, and n is an integer having a value of 0 to 8. Representative monomers of the above-described class include: dimethacrylate and diacrylates esters of 4,4′-bis-hydroxyethoxy-bisphenol A, dimethacrylate and diacrylates esters of bisphenol A, etc. These monomers are essentially described in Japanese Patent 70-15640 and in WO 5,106,928.

The (meth)acrylates used herein are known compounds and some are commercially available, for example from the SARTOMER Company under product designations such as SR®203, SR®295, SR®350, SR®351, SR®367, SR®399, SR®444, SR®454 or SR®9041.

Suitable examples of di(meth)acrylates are the di(meth)acrylates of cycloaliphatic or aromatic diols such as 1,4-dihydroxymethylcyclohexane, 2,2-bis(4-hydroxy-cyclohexyl)propane, bis(4-hydroxycyclohexyl)methane, hydroquinone, 4,4′-dihydroxybi-phenyl, Bisphenol A, Bisphenol F, bisphenol S, ethoxylated or propoxylated Bisphenol A, ethoxylated or propoxylated Bisphenol F or ethoxylated or propoxylated bisphenol S. Di(meth)acrylates of this kind are known and some are commercially available.

Other di(meth)acrylates which can be employed are compounds of the formulae (VI), (VII), (VIII) or (IX)
(VI),
(VII),
(VIII),
(VIII)
   in which
R₉ is a hydrogen atom or methyl,
Y is a direct bond, C₁-C₆alkylene, —S—, —O—, —SO—, —SO₂—or —CO—,
R¹⁰ is a C₁-C₈alkyl group, a phenyl group which is unsubstituted or substituted by one or more C₁-C₄alkyl groups, hydroxyl groups or halogen atoms, or is a radical of the formula —CH₂—OR₁₁ in which
R₁₁ is a C₁-C₈alkyl group or phenyl group, and
A is an alkylene group or a group of the formula

Further examples of possible di(meth)acrylates are compounds of the formulae (X), (XI), (XII) and (XIII)
(X),
(XI),
(XII),
(XIII)

These compounds of the formulae (VI) to (XIII) are known and some are commercially available. Their preparation is also described in EP-A-0 646 580.

Examples of commercially available products of these polyfunctional monomers are KAYARAD R-526, HDDA, NPGDA, TPGDA, MANDA, R-551, R-712, R-604, R-684, PET-30, GPO-303, TMPTA, THE-330, DPHA-2H, DPHA-2C, DPHA-21, D-310, D-330, DPCA-20, DPCA-30, DPCA-60, DPCA-120, DN-0075, DN-2475, T-1420, T-2020, T-2040, TPA-320, TPA-330, RP-1040, R-011, R-300, R-205 (Nippon Kayaku Co., Ltd.), Aronix M-210, M-220, M-233, M-240, M-215, M-305, M-309, M-310, M-315, M-325, M400, M-6200, M-6400 (Toagosei Chemical Industry Co, Ltd.), Light acrylate BP4EA, BP4PA, BP-2EA, BP-2PA, DCP-A (Kyoeisha Chemical Industry Co., Ltd.), New Frontier BPE-4, TEICA, BR-42M, GX-8345 (Daichi Kogyo Seiyaku Co., Ltd.), ASF-400 (Nippon Steel Chemical Co.), Ripoxy SP-1506, SP-1507, SP-1509, VR-77, SP4010, SP-4060 (Showa Highpolymer Co., Ltd.), NK Ester A-BPE-4 (Shin-Nakamura Chemical Industry Co., Ltd.), SA-1002 (Mitsubishi Chemical Co., Ltd.), Viscoat-195, Viscoat-230, Viscoat-260, Viscoat-310, Viscoat-214HP, Viscoat-295, Viscoat-300, Viscoat-360, Viscoat-GPT, Viscoat400, Viscoat-700, Viscoat-540, Viscoat-3000, Viscoat-3700 (Osaka Organic Chemical Industry Co., Ltd.).

Other (meth)acrylate compositions are those in which the free radically curable component contains a tri(meth)acrylate or a penta(meth)acrylate. Examples of suitable aromatic tri(meth)acrylates are the reaction products of triglycidyl ethers of trihydric phenols and phenol or cresol novolaks containing three hydroxyl groups, with (meth)acrylic acid.

Vinyl ethers that can be used as a radically polymerisable compound in the present invention include ethyl vinylether, n-propyl vinylether, isopropyl vinylether, n-butyl vinylether, isobutyl vinylether, octadecyl vinylether, cyclohexyl vinylether, butanediol divinylether, cyclohexanedimethanol divinylether, diethyleneglycol divinylether, triethyleneglycol divinylether, tert-butyl vinylether, tert-amyl vinylether, ethylhexyl vinylether, dodecyl vinylether, ethyleneglycol divinylether, ethylene-glycolbutyl vinylether, hexanediol divinylether, triethyleneglycol methylvinylether, tetraethyleneglycol divinylether, trimethylolpropane trivinylether, aminopropyl vinylether, diethylaminoethyl vinylether, ethylene glycol divinyl ether, polyalkylene glycol divinyl ether, alkyl vinyl ether and 3,4-dihydropyran-2-methyl 3,4-dihydropyran-2-carboxylate. Commercial vinyl ethers include the Pluriol-E200 divinyl ether (PEG200-DVE), poly-THF290 divinylether (PTHF290-DVE) and polyethyleneglycol-520 methyl vinylether (MPEG500-VE) all of BASF Corp.

Hydroxy-functionalised mono(poly)vinylethers include polyalkyleneglycol monovinylethers, polyalkylene alcohol-terminated polyvinylethers, butanediol monovinylether, cyclohexanedimethanol monovinylether, ethyleneglycol monovinylether, hexanediol monovinylether, diethyleneglycol monovinylether.

Another class of vinyl ethers that are suitable for inclusion are all those included in U.S. Pat. No. 5,506,087, which is incorporated herein by reference. More preferred are aromatic or alicyclic vinyl ethers. As an example, commercial vinylethers include Vectomer 4010, Vectomer 5015, Vectomer 4020, Vectomer 21010 and Vectomer 2020 of Allied Signal Corp., Morristown, N.J. Most preferred are Vectomer 4010 and Vectomer 5015.

Another class of polymerisable monomers includes vinyl-functionalized silicones (vinylsiloxanes), vinyl functionalized silatranes, vinyl functionalized alpha- or gamma-silanes and vinyl functionalized POSS compounds. To mention some, typical examples of vinylsiloxanes are: bis(m-allylphenyldimethylsilyloctyl)tetramethyldisiloxane (SIB1021.0) and the like, supplied by ABCR GmbH & Co. KG. and X-22-164B, X-22-164C, X-22-5002, X22-174D (modified silicone fluids) and the like supplied by Shin-Etsu Chemical Co., Ltd.. Typical example of vinyl functionalized silatranes is the methacryloxypropylsilatrane (SIM6487.1) and the like supplied by ABCR GmbH & Co. KG. Typical examples of vinyl functionalized α- or γ-silanes: styrylethyltrimethoxysilane (SIS6990.0), methacryloxymethyltrimethoxysilane (IM6483.0), methacryloxypropyltrimethoxysilane (SIM6487.4), methacryloxypropyltris(vinyldimethylsiloxy)silane (SIM6487.8), tetraallylsilane (SIT7020.0), norbornenyltriethoxysilane (SIB0992.0), vinyltriethoxysilane (Geniosil GF 56) vinyltris(2-methoxyethoxy)silane (Geniosil GF 58), vinyltriacetoxysilane (Geniosil GF 62), (3-mehtacryloxypropyl)trimethoxysilane (Geniosil GF 31), (methacryloxymethyl)methyldimethoxysilane (Geniosil XL 32), (methacryloxymethyl)trimethoxysilane (Geniosil XL 33), (methacryloxymethyl)methyldiethoxysilane (Geniosil XL 34), (methacryloxymethyl)triethoxysilane (Geniosil XL 36), and the like supplied by ABCR GmbH & Co. KG and Wacker-Chemie GmbH. Typical examples of vinyl functionalized POSS compounds are: styrenylisobutyl-POSS (ST1506), styrylcyclohexyl-POSS (ST1509), styrylcyclopentyl-POSS (ST1510, styrylisobutyl-POSS (ST1515), allylcyclohexyl-POSS (OL1099), allylcyclopentyl-POSS (OL1100), allylisobutyl-POSS (OL1118), allyldimethylsilylcyclopentyl-POSS (OL1105), cyclohexenylethylcyclopentyl-POSS (OL1110), allylcyclohexyl-POSS (OL1099), allylcyclopentyl-POSS (OL1100), allylisobutyl-POSS (OL1118), allyldimethylsilylcyclopentyl-POSS (OL1105), cyclohexenylethylcyclopentyl-POSS (OL1110), allylisobutyl-POSS (OL1118), allyldimethylsilylcyclopentyl-POSS (OL1105), cyclohexenylethylcyclopentyl-POSS (OL1110), dimethylvinylcyclopentyl-POSS (OL1114), diphenylvinylcyclopentyl-POSS (OL1117), monovinylcyclohexyl-POSS (OL1122), monovinylcyclopentyl-POSS (OL1120), monovinylisobutyl-POSS (OL1123), phenylmethylvinylcyclopentyl-POSS (OL1125), tris(dimethylvinyl)cyclopentyl-POSS (OL1154), tris(dimethylvinyl)cyclopentyl-POSS (OL1155), tris(dimethylvinyl)isobutyl-POSS (OL1119), trivinylsilylcyclopentyl-POSS (OL1157), methacrylfluoro(3)cyclo[pentyl-POSS (MA0720), methacrylfluoro(13)cyclopentyl-POSS (MA0730), methacryltrimethylsiloxycyclopentyl-POSS (MA0740), methacryltrimethylsiloxyisobutyl-POSS (NA0742), methacrylisobutyl-POSS (MA0702), methacrylisooctyl-POSS (MA0719), methacrylphenyl-POSS (MA0734), methacryldisilanolcyclohexyl-POSS (MA0715), methacryldisilanolcyclopentyl-POSS (MA0711), methacryldisilanolisobutyl-POSS (MA0713), methacryl-POSS cage mixture (MA0735), octamethacryldimethylsilyl-POSS (MA0745), tris(methacryl)cyclohexyl-POSS (MA0747), trismethacrylisobutyl-POSS (MA0750), acrylocyclehexyl-POSS (MA0699), acrylocyclopentyl-POSS (MA0700), acryloisobutyl-POSS (MA0701), methacrylcyclohexyl-POSS (MA0704), methacrylcyclopentyl-POSS (MA0705), methacrylethyl-POSS (MA0717), octacyclohexenyldimethylsilyl-POSS (OL1159), octavinyldimethylsilyl-POSS (OL1163), octavinyl-POSS (OL1160), vinyl-POSS cage mixture (OL1170) and tetra vinyl-T2 (OL1150) and the like supplied by Hybrid Plastics (USA).

With some known techniques, adhesion is obtained by special adhesives compositions i.e. silicon-based polymers or oligomers or hybrids (silicon/acrylics). Sometimes a siloxane oligomer is added to the acrylate oligomer and both are cross linked together via amine compounds. Behavior of such hybrid compositions may be difficult to predict. Preferably the invention does not make use of that kind of compositions.

Preferably the amine functions of the organo-boron complex reacts with acrylate functions to form Michael adducts of amine-acrylic. Preferably the acrylic part of the adhesive composition according to the present invention is free of siloxane or other silicon compounds especially the compounds able to polymerise together with the acrylic oligomer, momomer or polymer.

Other Ingredients

With some known techniques, adhesion is obtained by special adhesives compositions i.e. silicon-based-polymers or oligomers or hybrids (silicon/acrylics). Sometimes a siloxane oligomer is added to the acrylate oligomer and both are cross linked together via amine compounds. Behavior of such hybrid compositions may be difficult to predict; hybrid systems are complex and ensuring full cure is not easy. Moreover, for adhesives composition silicon content must be limited to ensure proper adhesion. Preferably the invention does not make use of that kind of compositions.

Preferably the amine functions of the organo-boron complex reacts with acrylate functions to form Michael adducts of amine-acrylic. Preferably the adhesive component contains is free of separate silicon compound such as silanol compounds. Acrylic compound may have silicon functions within the acrylic molecule. Preferably the adhesive part of the adhesive composition according to the present invention is free of siloxane or other silicon compounds especially the compounds able to polymerise together with the acrylic oligomer, momomer or polymer.

An epoxy-terminated amine-epoxy adduct, that is to say an adduct between one or more molecules containing at least two epoxy rings and one or more compounds containing at least one amine groups such that there is a stoichiometric excess of the epoxy rings. Carboxylic acid anhydrides, carboxylic acids, phenolic novolac resins, thiols (mercaptans), water, metal salts and the like may also be utilized as additional reactants in the preparation of the amine-epoxy adduct or to further modify the adduct once the amine and epoxy have been reacted.

Specific examples of suitable commercially available epoxy resins are those sold under the trade mark ARALDITE such as the MY-series (e.g. MY-0500, MY-0510, MY-0501, MY-720, MY-740, MY-750, MY-757, MY-790, MY-791, etc.), the GY-series (e.g. GY-240, GY-250, GY-260, GY-261, GY-282, etc.) (HUNTSMAN (previously VANTICO A. G., Switzerland), DER-324, DER-332, DEN431, DER-732 (DOW Chemical Co., USA), EPON 813, EPON 8021, EPON 8091, EPON 825, EPON 828, Eponex 1510, Eponex 1511 (SHELL Chemical Co. USA), PEP 6180, PEP 6769, PEP 6760 (Pacific Epoxy Polymers Inc. USA), NPEF-165 (Nan Ya Plastic Corporation, Republic of China), Ricopoxy 30, Ricotuff 1000-A, Ricotuff-1100-A, Ricotuff-1110-A (Ricon Resins Inc., USA), Setalux AA-8502, Setalux 8503 (AKZO Nobel, Netherlands), to mention just a few.

Another useful adjuvant is a cross-linking agent. Cross-linking agents can be used to enhance the solvent resistance of the adhesive bond or polymer composition. The cross-linking agent can increase the use temperature and the solvent resistance of the cured polymer or adhesive. Typically employed in an amount of 0.1 to 20% w/w based on the total weight of the compositions, useful cross-linkers include the various diacrylates, referred to above as possible acrylic modifying monomers, and compounds with acrylate and isocyanate functionality as well as other materials Particular examples of suitable cross-linking agents include ethylene glycol, dimethacrylate, ethylene glycol diacrylates, triethylene glycol dimethacrylate, diethylene glycol dimethacrylate, diethylene glycol bismethacryloxy carbonate, polyethylene glycol diacrylates, tetraethylene glycol dimethacrylate, diglycerol diacrylates, diethylene glycol dimethacrylate, pentaerythritol triacrylate, trimethacrylate tris(2-methyl-1-aziridinepropionate, trimethylolpropane trimethacrylate, acrylate tipped polyurethane containing prepolymers, polyether diacrylates and dimethacrylates.

The compositions of the present invention optionally include a phosphorous-containing compound having one or more olefinic groups and at least one P-OH group. This class of compounds is in essence described in p. 23-24, WO 03/040151.

The compositions of the present investigation may also contain metal salts as those described in detail in WO 03/057791. These metal salts can modify the curing kinetics of a polymerizable composition and are known in the art as “metal salt modifiers”.

The compositions may optionally contain a non-organoborane-based free radical initiator (aerobic initiator), which are well known in the art. A non-organoborane free radical initiator can readily be contained in the polymerizable monomer part of a two-part polymerizable composition. Preferred non-organoborane free radical initiators are those, which do not readily react with monomer under shelf-aging conditions, or can be inhibited suitably to provide desired shelf stability of up to several months, if needed. Illustrative examples of suitable non-organoborane-based free radical initiators include organic peroxides and organic hydroperoxy initiators, particularly those organic hydroperoxides having the formula R′OOH where in R′ is a hydrocarbon radical containing up to about 20 carbon atoms, preferably an alkyl, aryl or arylalkyl radical of 1 up to 14 carbon atoms. Specific examples of such hydroperoxides are cumene hydroperoxide, tertiary butyl hydroperoxide, methyl ethyl ketone peroxide and peroxides formed by the oxygenation of various hydrocarbons such as methylbutene, cetane, and cyclohexane and various ketones and ethers. Other examples of useful initiators include hydroperoxides such as p-menthane hydroperoxide, 2,5-dimethylhexane, 2,5-dihydroxyperoxide and the like and also silyl-type peroxides. Some (not all) types of compounds that can be useful as aerobic initiators are also described in essence in U.S. Pat. No. 4,043,982. Additionally, more than one non-organoborane-based free radical initiators may be employed, such as a mixture of hydroperoxides with peresters, such as t-butyl perbenzoate or t-butyl-peroxymaleate can be advantageously used. Cumene hydroperoxide is especially preferred.

The compositions of the invention may contain a reactive or non-reactive diluent to balance the volume of the two parts of the composition so as to achieve a commercially acceptable volumetric ratio of the two component& Preferably the diluent is a reactive diluent. Preferred reactive diluents are isocyanate reactive compounds as in essence described in WO 03/038006, 1,4-dioxo-2-butene functional materials as in essence described in WO 00/56779, aziridine functional materials as in essence described in WO 98/17694 WO 99/64528, WO 99/64475, various types of waxes e.g. petroleum [paraffin (crystalline) wax, microcrystalline wax and petroleum wax], vegetable (typical examples: carnauba wax, Japan wax, ouricury wax, rice-bran wax, jojoba wax, castor wax, bayberry wax, soy bean wax, etc.) insect and animal (typical examples: beeswax, spermaceti wax, Chinese wax, wool wax, shellac wax, etc.), mineral (typical examples: montan wax, peat wax, ozokerite wax, ceresin wax, etc.), synthetic waxes (typical examples: polyethylene waxes, a-olefin waxes, carbowaxes, halowaxes, etc.), etc., as in essence described in WO 03/035703, unsaturated hydrocarbons such as 2,6-dimethyl-2,4,6-octatriene and the like, and mostly desirable any liquid complex of those described by the general formula II. Another class of desirable diluents include those selected from certain ethers, epoxies, and hydrocarbons and more specifically poly(tetrahydrofurane), 2-haloalkyl phenyl ethers such as 2-bromoethyl phenyl ether, 2-chloro ethyl phenyl ethyl, glycidoxy alkyltrialkoxy silanes such as 3-glycidoxypropyltrimehoxysilane, certain glycidyl ethers such as glycidyl heptyl ether, glycidyl undecyl ether, glycidyl ether, glycidyl heptyl ether, propanediol diglycidyl ether, butenediol glycidyl ether, cyclohexane dimethanol diglycidyl ether, 2-ethyl hexyl glycidylether, 1-benzyl-2,3-isopropylidene-S/N-glycerol, and the like. Triglyme and tetraglyme are particularly desirable.

The compositions may further comprise a variety of optional additives. The various optional additives are employed in an amount that does not significantly adversely affect the polymerization process of the desired properties of compositions made therewith. The quantity of thixotropic agent(s) is desirably adjusted so as to provide a dough, which does not exhibit any tendency to flow at room temperature. One particularly useful additive is a thickener such as medium to high (10.000 to 1.000.000 a.u.) molecular weight poly(methyl methacrylate) which may be incorporated in an amount of 0.1-60% w/w, preferably in an amount of 0.2-20% w/w, and most preferably of 0.4-10% w/w, based on the total weight of the composition. Thickeners may be employed to increase the viscosity of the composition to facilitate application of the composition. Preferable materials of this class are poly(methyl methacrylate) homo- and co-polymers under the trademark ELVACITE commercially available from Lucite International and also styrene/methyl methacrylate co-polymers and polybisphenol-A maleate or propoxylated bisphenol-A fumarate polyester (trademark ATLAC). It is also possible to add inert filling materials such as finely divided silica, fumed silica (treated or untreated) (e.g. tradename AEROSIL), montmorillonite, clay, bentonite and the like. The use of microionized silica would result in a paste-like thixotropic composition. Polymeric thickeners or other thickeners such as silicas may suitably be present -in a two-component composition- as a thickener for the diluent in the hardener's part.

Another particularly useful additive is an elastomeric material. The materials may improve the fracture toughness of compositions made therewith which can be beneficial when, for example, bonding stiff, high yield strength materials such as metals substrates that do not mechanically absorb energy as easily as other materials, such as flexible polymeric substrates. Such additives can be incorporated in an amount of 5-50% w/w, based on the total weight of the composition. Preferably these elastomers of rubber polymers are those based on polyisoprenes, polybutadienes (homo- and co-polymers), polyolefines, polyurethane, polyesters, etc. Typical examples of elastomeric materials include homopolymers such as polybutadiene, polyisoprene and polyisobutylene; diene type copolymers such as butadiene/styrene copolymer, butadiene/acrylonitrile copolymer, butadiene/methyl methacrylate copolymer and butadiene/alkyl acrylate copolymer; ethylene/vinyl acetate copolymers; ethylene/alkyl acrylate copolymers (1-8) carbons in the alkyl group), rubbery polyalkyl acrylates or copolymers thereof; polyurethane; chlorinated polyethylenes; and EPDM (ethylene/propylene/diene terpolymers). The elastomers of these structures may contain a functional group at one or both ends or within a particular segment or repeating unit of the copolymer. Among the suitable functional groups are vinyl, epoxy, carboxyalkyl and mercapto groups. Other functional groups may be employed as deemed useful and upon proper experimentation. Useful elastomeric modifiers include chlorinated or chlorosulphonated polyethylenes such as HYPALON 30 and block copolymers of styrene and conjugated dienes (trademarks: VECTOR, KRATON, STEREON). Also useful and even more preferred are certain graft copolymer resins such as particles that comprise rubber or rubber-like cores or networks that are surrounded by relatively hard shells, these materials often being referred to as “core-shell” polymers. Most preferred are the acrylonitrile/butadiene/styrene and methyl methacrylate/butadiene/styrene graft copolymers. In addition, to improve the fracture toughness of the composition, core shell polymers can also impart enhanced spreading and flow properties to the uncured composition. These enhanced properties may be manifested by a reduced tendency for the composition to leave an undesirable “string” upon dispensing from a syringe-type applicator, or sag or slump after having been applied to a vertical surface. Use of more than 10% w/w of a core shell polymer additive is desirable for achieving improved sag-slump resistance. Generally, the amount of toughening polymer used is that amount which gives the desired toughness to the polymer or to the adhesive prepared.

The compositions of the invention can contain a heat management material. Any material, which functions to dissipate heat during polymerization, may be used. Examples of useful heat management materials include volatile liquids, which evaporate during the reaction as a result of absorbing heat-generated heat, and materials, which react via an endothermic reaction under conditions of the reaction. Materials useful as heat sinks are materials with high heat capacities. Examples of materials with high heat capacities include ceramic particles, glass beads, fluoropolymer powders (e.g. TEFLON powders) and hollow spheres. In the case of adhesives the role of glass beads and hollow spheres can be also that of bond spacer controllers. Useful liquid materials include, chlorinated alkanes, dialkyl ethers, alkanes, methylene chloride and low boiling point petroleum ethers. More preferred solvents include methylene chloride, diethyl ether, pentane and hexane. The amount of heat management material used is dependent on the target reaction temperature and the heat capacity of the heat management material. The heat of reaction can also be impacted by slowing down the rate of mixing thereby allowing for slower heat generation.

Preferably the average temperature of the adhesive (when the curing of the later is not triggered by heating, or by the application of actinic radiation or by electromagnetic radiation or by magnetic radiation, electrical current, ultrasounds, ultraviolet radiation combinations thereof or any other means that result to the aforementioned specie of radiation or heat) over its working time is managed to a target of 70° C. or less, preferably 60° C. or less and most preferably 50° C. or less. The heat management material can be placed on either the resin side (polymerizable mixture) of the formulation or on the hardener side. The selection of the heat management material and its amount are driven by the amount of heat that needs to be dissipated during the polymerization. If the heat generated during the reaction is too high for too long of a period of time, the adhesion of the polymerized composition to a substrate may be negatively impacted.

The composition may also contain known catalysts for the reaction of an isocyanate reactive compound with an isocyanate-containing compound or for the reaction of an epoxy reactive material with an epoxy-containing compound.

The compositions may also include one or more of the following: fillers (e.g. alumina, glass powder, ceramic powder and metal powder) that may also contribute to the theological control of the composition different to those mentioned already in the paragraph associated to thixotropic agents; reinforcement fibres, e.g. glass-, carbon-, basalt wollastonite, ceramic, aramid fibres and mixtures thereof; silicone rubbers, silicone core-shell particles; reinforcing agents and/or pigments e.g. metal oxides, metal hydrates, metal hydroxides, metal aluminates, metal carbonates/sulphates, starches, talcs, kaolins, molecular sieves, organic pigments, etc.); solvents (they should be selected to have boiling points below the thermal dissociation temperature of the organosilicon organoborane complex); other flow modifiers; other calcium carbonate (including coated and/or precipitated calcium carbonate, which may also act as a thixotropic or rheological control agent, especially when it is in the form of fine particles), alumina, clays, nanoclays (e.g. natural montmorillonites, etc.), or nano-organoclays (e.g. intercalated montmorillonites, etc.) or modified sand, metals (e.g., aluminum powder), microspheres (glass microspheres, thermoplastic resin, ceramic and carbon microspheres, which may be solid or hollow, expanded or expandable), and any of the other organic or inorganic fillers known in the art; additives commonly used in adhesives, sealants, paints and coatings, casting resins, cables, in shapable moulding materials and in finished mouldings or in composite materials; plasticizers, ;adhesion promoters (also known as wetting or coupling agents; e.g., silanes, titanates, zirconates), colorants (e.g., dyes and pigments such as carbon black), stabilizers (e.g., antioxidants, UV stabilizers), and the like; coloring agents (pigments and dyes); antifoaming agents; leveling agents; flame retardants; antioxidants; etc.

Preferred compositions are 2 part and comprise:

Part 1: the silicon-amino organo-borane complex with optional chain extender, eg an aziridine compound;

And

Part 2: the acrylic compositions made up of

a blend of radically polymerisable compounds, preferably methacrylic compounds chosen for mutual compatibility and final cured properties;
optionally containing toughener materials [eg ABS];
decomplexer, preferably multi-functional aldehyde, and
open time extender, eg preferably a second radical accepting species such as 4-methylstyrene, or other alkenyl compounds.

The inventions extends to a process for the preparation of a complex which comprises contacting a solution of an organoborane compound of the general formula (I) with an organosilicon compound that has the general formula II. The invention extends to a process for the preparation of a complex, which comprises contacting a solution of an organoborane compound of the general formula (I) with an organosilicon compound that has the general formula V. The invention further extends to a process for the preparation of a complex, which comprises contacting a solution of an organoborane compound of the general formula (I) with an organosilicon compound as those described in the claims. The process may comprises contacting a solution of an organoborane compound of the general formula (I) with an organosilicon compound containing at least one primary, secondary or tertiary amino group.

The polymerization of a polymerizable composition according to th present invention may be initiated by heating, or by the application of actinic radiation or by electromagnetic radiation or by magnetic radiation, electrical current, ultrasounds, ultraviolet radiation combinations thereof or any other means that result to the aforementioned specie of radiation or heat Preferably, the composition contains a radically polymerisable monomer and/or oligomer which is preferably an olefinically unsaturated system, as an acrylate or methacrylate compound> Preferably, the radically polymerisable monomer and/or oligomer comprises any compounds selected from the following group: 2 ethylhexyl methacrylate, 2-ethylhexyl methacrylate, 2-ethoxyethyl methacrylate, cyclohexyl methacrylate, isobornyl methacrylate, isooctyl acrylate, isooctyl methacrylate, isobutyl methacrylate, n-butyl methacrylate, cyclohexyl methacrylate, cyclohexyl acrylate, n-hexyl methacrylate, isobornyl methacrylate, isodecyl methacrylate and isodecyl acrylate. The may further contain at least one of the following: i) pigments, ii) colorants, iii) UV-stabilizers, iv) inhibitors, v) moisture scavengers, vi) free-radical initiators other than organoborane (e.g. organic peroxides, hydroperoxides etc.), vii) sulfonated aromatic polymers, viii) epoxy compounds, ix) epoxy-terminated amine-epoxy adducts, x) additional crosslinking agents, xi) phosphorous containing compounds that contain at least one P—OH group, xii) substances for modifying the curing kinetics (“modifiers”) (e.g. metal salts etc.), xiii) rheology control substances (thickeners or thinners) (flow modifiers), xiv) various kinds of silica (e.g. finely divided silica, fumed silica, micro ionized silica, etc.), xv) volatile liquids, xvi) elastomeric materials, xvii) ceramic particles, xviii) glass beads, xix) fluoropolymer powders, xx) microspheres (e.g. glass, thermoplastic resin, ceramic or carbon, solid or hollow, expanded or expandable), xxi) catalysts for epoxy or isocyanate type reactions, xxii) solvents, xxiii) reactive or non reactive diluents (e.g. 1,4-dioxo-2-butene functional materials, aziridine functional materials, various waxes etc.), xxiv) fillers (e.g. alumina, glass powder, ceramic powder, metal powder, etc.), xxv) reinforcement fibres/agents, xxvi) silicone rubbers, xxvii) silicone core-shell particles, xxviii) plasticizers, xxix) adhesion promoters, xxx) antifoaming agents, xxxi) leveling agents, xxxii) modified sand, xxxiii) antioxidants, xxxiv) flame retardants. The composition can furthermore contain other additives commonly used and known in the art of adhesives, sealants, paints, coatings, stain blocking compositions, casting resins, in shapable moulding materials, in finished mouldings or in composite materials.

The invention provides a method of adhesively bonding at least two substrates together, which comprises applying a polymerisable composition as claimed to a first substrate, positioning a second substrate in contact with the first substrate via said product, and allowing or causing said composition to cure. Preferably, the polymerisable composition is applied to a first substrate, positioning a second substrate in contact with the first substrate via said product, and allowing or causing said composition to cure. A method of adhesively bonding at least two substrates together, is also provided, which comprises applying a complex to the surface of a substrate; subsequently applying a composition comprising a radically polymerisable monomer or oligomer to the thus-primed surface; and subsequently applying a second substrate. Preferably, the second substrate is similarly treated.

The two substrates may be independently selected from the group of thermoplastics, thermosets, wood, composites, ceramics, glass, concrete, and metals. Preferably, at at least one substrate is a low surface energy substrate, more preferably.

A substrate comprising polyethylene, polypropylene, copolymers of a-olefins, or fluorinated polymers (e.g polytetrafluoroethylene, etc.) and other plastics of comparable or higher surface energy. Said substrates may comprises homo- or co-polymers of methyl methacrylate, polycarbonate, poly(vinyl chloride), acrylonitrile-butadiene-styrene and other plastics of comparable or higher surface energy.

Preferably, any of the two-component polymeric compositions of the is premixed via preferably a suitable dispenser. In other embodiments, any of the two-component polymeric compositions is applied on the substrates without premixing.

The compositions of the invention may be used in the preparation of adhesives, sealants, paints, coatings, stain blocking compositions, casting resins, in shapable moulding materials, in finished mouldings or in composite materials.

The polymeric adhesive composition can be a two-part curable adhesive composition comprising: a) a first part comprising at least one radically polymerizable monomer/oligomer and at least one decomplexer and b) a second part comprising at least one of any of the complexes as claimed in any one of the claims 1 to 10. Preferably, the first part and the second part are combined in a whole number ratio of 1:1 to 35:1 and more preferably of2:1 to 25:1 and most preferably 4:1 to 10:1.

Methods of Application and Bonded Articles

The novel two-part polymerisable compositions of the present invention can be prepared in a known manner by, for example, premixing individual components and then mixing these premixes, or by mixing all of the components using customary devices, such as stirred vessels, often at slightly elevated temperature. The physical form of the composition and its constituent parts will depend upon the intended application, and may for example be a powder, a paste, or a liquid. The formulation of products as a liquid is often preferred for commercial applications.

When the compositions of this invention are formulated as a two-part product, the two parts may be mixed for curing in any suitable ratio; they may for example be presented in packs containing convenient whole number mix ratio of 1:50 or less, for example 1:10, 1:4, 1:3, 1:2 or 1:1, such that they can easily be used with two-part dispensers. For a two-part adhesive such as those of the invention to be most easily used in commercial and industrial environments, the ratio at which the two parts are combined should be a convenient whole number. This facilitates application of the adhesive with conventional, commercially available dispensers (e.g. under the trademark “MixPac®”). Such dispensers are sometimes described as dual syringe-type applicators. Detailed description of such dispensers and their mode of application can be found in WO 00/56779, U.S. Pat. No. 4,538,920, U.S. Pat. No. 5,082,147. For best commercial and industrial utility and for ease of use with currently available dispensing equipment, the two parts of the adhesive should be capable of being combined in a common, whole number mixing ratio such as 1:50 or less, more preferably 1:10, 1:4, 1:3, 1:2 or 1:1.

The polymerizable composition can be easily applied and cured at ambient temperature. Typically, it is applied to one or both substrates and then the substrates are joined together with pressure to force excess compositions out of the bond line. In general, the bonds should be made shortly after the composition has been applied, preferably within about 3 h and more preferable in less than 2 h. The typical bond line thickness is about 30-1000 microns, preferably 50-500 and most preferably 80-350. The bonding can be easily carried out at room temperature. The bonds preferably cure to a reasonable handling strength (0.4 MPa) within 3 hours and most preferably less than 2. Full strength is reached in about 24-48 hours and more preferably in about 10-18 or most preferably in less than 10; post-curing with heat (typically about 35-180° C., preferably about 40-120° C. and most preferably 50-90° C.) may be used if desired. Even more rapid strength build-up is facilitated by the inclusion of crosslinking agents or cyclic anhydride-functional or vinyl unsaturated anhydride-functional reactive compounds in the polymerizing mixture. The following data and examples illustrate the invention:

Raw Materials

The raw materials and supplier details are presented in Table 1.

TABLE 1

| Raw material | Supplier | Description | Data |
|---|---|---|---|
| Triethylborane (TEB) intetrahydrofuran | CALLERY | Solution of TEB in THF | 14.5% w/w TEB in THF |
| (THF) | | | |
| Sartomer R-203 | SARTOMER | Methacrylate | MW = 170.2 a.u. |
| (Tetrahydrofurfurylmethacrylate) | | | |
| (THFMA) | | | |
| 2-Ethythexylmethacrylate (EHMA) | ALDRICH | Methacrylate | MW = 196.31 a.u. |
| Trimethylolpropanetrimethacrylate (TMPTA) | ALDRICH | Methacrylate | MW = 338.4 a.u. |
| BLENDEX 360 | GE Specialty | ABS rubber | 50% Butadiene, particle |
| | Chemicals | | size = 250 microns |
| ELVACITE 2010 | LUCITE Intl. | Poly(methyl methacrylate) | MW = 80.000 a.u. |
| MY-0510 | HUNTSMAN | Epoxy resin | Epoxy equivalent weight = 101, |
| | | | functionality = 3 |
| Fillite 160W | TRELLEBORG | Ceramiccenospheres | Particle size (% passing); |
| | FILLITE Ltd. | | 100% 180 microns, |
| | | | 28% 100 microns |
| AEROSIL 200 | DEGUSSA | Hydrophilic fumed silica | BET surface area = 200 +/− 25 m²/g, |
| | | | average primary particle size = 12 nm |
| Trimethylolpropane tris | ALDRICH | Aziridine | MW = 467.61 a.u. |
| (2-methyl-1-aziridinepropionate) | | | |
| KF-857 | SHIN-ETSU | Organoamino functinalized silicone | Amine equivalent weight = 800 a.u. |
| | | | (amino functionality: 3) |
| X22-161AS | SHIN-ETSU | Organoamino functinalized silicone | Amine equivalent weight = 415 a.u. |
| | | | (amino functionality: 2) |
| KBM-603 | SHIN-ETSU | 3-(2-Aminoethylamino)propyltrimethoxysilane | MW = 222.4 a.u. |
| KBE-903 | SHIN-ETSU | (3-Aminopropyl)triethoxy silane | MW = 221.4 a.u. |
| KBM-903 | SHIN-ETSU | (3-Aminopropyl)trimethoxy silane | MW = 179.1 a.u. |
| SLM-88705 | WACKER | (Aminomethyl)trimethoxy silane | MW = 165.3 a.u. |
| AM0270 | HYBRID | Aminopropylisooctyl-POSS | MW = 1267 a.u. |
| | PLASTICS | | |
| Glutaric acid (GA) | ALDRICH | | MW = 132.1 a.u. |
| Methacrylic acid (MA) | ALDRICH | | MW = 88.1 a.u. |
| Succinic anhydride (SA) | ALDRICH | | MW = 100.1 a.u. |
| Methacrylic anhydride (MAN) | ALDRICH | | MW = 154.2 a.u. |
| Mono-2-(methacryloyloxy)ethyl maleate | ALDRICH | | MW = 228.2 a.u. |
| (MEM) | | | |
| Mono-2-(methacryloyloxy)ethyl succinate | ALDRICH | | MW = 230.2 a.u. |
| (MES) | | | |

Pyrophoricity of Organosilicon Organoborane Complexes

The pyrophoricity of organosilicon organoborane complexes was tested according to the method described in U.S. Pat. No. 5,690,780.

Thermal Disassociation of Organosilicon Organoborane Complexes

The thermal disassociation of organosilicon organoborane complexes was assessed by Differential Scanning Calorimetry (DSC). DSC measurements from −40° C. to 280° C., were carried out on a Mettler 820, in air atmosphere at a heating rate of 20° C./min. The onset temperature of the exotherm due to the organosilicon organoborane complex's disassociation was recorded (disassociation temperature).

Melting Point Measurements of Organosilicon Organoborane Complexes

The melting points of certain new organosilicon organoborane complexes was assessed by Differential Scanning Calorimetry (DSC). DSC measurements from −50° C. to 150° C., were carried out on a Mettler 820, in air atmosphere in open aluminium pans and at a heating rate of 10° C./min.

Adhesive Test Methods

Polypropylene, polypropylene copolymer, polyvinyl chloride, polytetrafluoroethylene, polymethylmethacrylate substrates and aluminium were degreased by wiping with tissue paper soaked in acetone. Polycarbonate, low and high density polyethylene as well as ABS substrates were degreased with isopropanol. No surface abrasion, priming, or other surface pre-treatment was applied in the case of plastic substrates. All the plastic substrates were purchased from Engineering and Design Plastics Ltd. (Cambridge, U.K., www.edplastics.co.uk). Steel substrates were sandblasted. The adhesive composition was dispensed onto one face of each substrate pair. The two substrates were mated (see Table 2 for bond area) and held to each other with two bulldog clamps. Small amounts of adhesive squeezed out of the overlapped area were allowed to remain. The dimensions and bonded areas of the test coupons are shown in Table 2. The bonded joints were left to cure for 48 h at 25° C. (unless otherwise stated). The clamps were then removed and the bonded joints were tested for tensile shear strength (TSS) on a tensile tester (Instron 4467) at crosshead speed of 2.54 mm/min according to ISO 4587. The TSS values were recorded in megapascals (MPa) and the failure mode is reported as:
AF (adhesive failure): delamination between adhesive and substrate.
CF (cohesive failure): failure within the adhesive layer.
SF (substrate failure): bonded substrate breaks.

SN (substrate necking: bonded substrate yields (plastic deformation).

TABLE 2

| | | | | Bond area |
|---|---|---|---|---|
| | Width | Length | Thickness | (width × 12.5 mm) |
| Substrates of the overlap bond pair | (mm) | (mm) | (mm) | (mm²) |
| Polytetrafluoroethylene (PTFE—PTFE) | 20 | 85 | 4 | 250.0 |
| Polytetrafluoroethylene (PTFE6—PTFE6) | 20 | 85 | 6 | 250.0 |
| Polypropylene (PP—PP) | 25 | 85 | 3 | 312.5 |
| Polypropylene copolymer (CPP—CPP) | 25 | 85 | 3 | 312.5 |
| Low density polyethylene (LDPE—LDPE) | 25 | 85 | 3 | 312.5 |
| High density polyethylene (HDPE—HDPE) | 25 | 85 | 3 | 312.5 |
| Polyvinyl chloride (PVC—PVC) | 25 | 85 | 3 | 312.5 |
| Poly(methyl methacrylate) (PMMA—PMMA) | 25 | 75 | 3 | 312.5 |
| Poly(Acrylonitrile-Butadiene-Styrene) (ABS—ABS) | 25 | 85 | 3 | 312.5 |
| Polycarbonate (PC—PC) | 25 | 85 | 3 | 312.5 |
| Aluminium (AL—AL) | 25 | 115 | 1 | 312.5 |
| Steel (STL—STL) | 25 | 115 | 1 | 312.5 |
| Polypropylene & Steel (PP—STL) | 25 | 85/115 | 3/1 | 312.5 |

The strength build-up (tensile shear stress vs. curing time) of a competitor's product (COPR) on a polypropylene-polypropylene joint was also evaluated and compared to the strength of an adhesive formulation prepared herein. A series of joints has been prepared by applying the COPR to both substrates via a dual-syringe-type applicator (10:1 v/v). The joints prepared as mentioned here before, left to cure for 1, 2, 4, 6 and 24 h at 23° C.

### EXAMPLES

### Example 1

Synthesis of Organoborane Complexes

The complexation reactions between triethylborane (TEB) and the complexing agents were carried out in N₂ atmosphere. A 50-mL conical flask was charged with the complexing agent (or a solution of the complexing agent in a volatile solvent preferably THF) and it was placed into an ice-bath and on an analytical scale. The required amount of TEB (4.5% w/w, tetrhydrfurane (THF) solution) was transferred via a syringe into the conical flask. Upon completion of the addition of TEB, the reaction mixture (along with the ice-bath) was removed from the analytical scale and was stirred for 4-6 h. The flask was then removed from the inert atmosphere and left at ambient temperature in air for 3 to 5 days for the THF to evaporate. The evaporation process was tracked via weight loss measurements over time. The evaporation process was considered complete when no further weight loss was recorded, which takes into account weight loss due to any hydrolysis products. Table 3 presents the newly synthesized complexes, which are storage, stable at ambient temperature and none of them is pyrophoric.

TABLE 3

| Organoborane | | Mol Ratio | |
|---|---|---|---|
| complex | Complexing | (TEB/complexing | |
| (Part B) | Agent | agent) | Physical State |
| C1 | KF-857 | 1:1 | Transparent liquid |
| C2 | KF-857 | 2:1 | Transparent liquid |
| C3 | KF-857 | 3:1 | Transparent liquid |
| C4 | KF-857 | 7:1 | Transparent liquid |
| C5 | X22-161AS | 2:1 | Transparent liquid |
| C6 | X22-161AS | 3:1 | Transparent liquid |
| C7 | AM0270 | 1:1 | Yellow liquid |
| C8 | AM0270 | 3:1 | Yellow liquid |
| C9 | KBM-603 | 1:1 | Transparent liquid |
| C10 | KBM-603 | 2:1 | Transparent liquid |
| C11 | KBM-903 | 1:1 | Transparent liquid |
| C12 | KBE-903 | 1:1 | Transparent liquid |
| C13 | SLM-88705 | 1:1 | White solid |

All the above complexes showed different disassociation temperatures all higher than 25°, for example the disassociation temperatures of C1 and C3 were 65 and 45° C. respectively.

When neat TEB reacted with KBM-903 or KBE-903 in an equimolar ratio then the corresponding complexes (C11 and C12 of Table 3) were obtained as crystalline solids.

C11:

Melting temperature range: 38-59oC (peak at 43oC), DHmelting=−154.05 J/g

C12:

Melting temperature range: 13-33oC (peak at 25oC), DHmelting=−62.79 J/g

### Example 2

In some cases the aforementioned complexes were combined with aziridine or with each other. Table 4 depicts these combinations.

TABLE 4

| Mixture of | | | | | |
|---|---|---|---|---|---|
| Organoborane | | | | Weight Ratio | Weight Ratio |
| Complex | Organoborane | Organoborane | | (Organoborane complex A/ | (Organoborane complex A/ |
| (Part B) | complex A | complex B | Diluent | Organoborane Complex B) | Diluent) |
| C14 | C9 | — | aziridine | — | 2.3 |
| C15 | C12 | C2 | — | 1.5 | — |
| C16 | C12 | C3 | — | 1.5 | — |
| C17 | C12 | C7 | — | 1.5 | — |
| C18 | C9 | C1 | — | 2.7 | — |
| C19 | C9 | C7 | — | 2.7 | — |
| C20 | C10 | — | aziridine | — | 1.0 |
| C21 | C12 | C5 | — | 1.5 | — |
| C22 | C12 | C6 | — | 1.5 | — |
| C23 | C12 | — | aziridine | — | 2.3 |

### Example 3

General Preparation Procedure for Part A of the Adhesives

A mixture of methacrylates, the decomplexer (or a solution of the decomplexer in TRFMA in cases where the decomplexer is a solid), BLENDEX-360 and ELVACITE-2010 were sheared in a high-shear mixer at approx. 3000 rpm for 1 h. FILLITE-160W was then added to the slurry and mixing was continued for another 10 min at 500 rpm.

In some cases (A1-A10, Table 5) after 1 h of mixing the methacrylates, decomplexer, BLENDEX-360 and ELVACITE-2010, an addition of AEROSIL 200 to the mixture was made, and mixing continued at 3000 rpm for another 10 min. At the end FILLITE-160W was added to the slurry and mixing continued for another 10 min.

In one case (A11, Table 5), epoxy resin MY-0510 was added to the mixture of methacrylates, decomplexer BLENDEX-360 and ELVACITE-2010. After 1 h of mixing, AEROSIL 200 was added and mixing at 3000 rpm continued for another 10 min. At the end FILLITE-160W was added to the slurry and mixing continued for another 10 min.

In one case (A39, Table 5), no decomplexer was added to the mixture of methacrylates, BLENDEX-360 and ELVACITE-2010. After 1 h of mixing, FILLITE-160W was added to the slurry and mixing continued for another 10 min.

A series of different compositions of Part A of the adhesives is depicted in Table 5.

TABLE 5

| | | Methacrylates | | | Decomplexer | | | | |
|---|---|---|---|---|---|---|---|---|---|
| | Adhesive | THFMA | EHMA (% | TMPTA | MEM | MES | MAN | MA | SA |
| Example | (part A) | (% w/w) | w/w) | (% w/w) | (% w/w) | (% w/w) | (% w/w) | (% w/w) | (% w/w) |
| 1 | A1 | 51.66 | 18.96 | | 13.06 | | | | |
| 2 | A2 | 54.30 | 19.93 | | 8.59 | | | | |
| 3 | A3 | 55.31 | 20.30 | | 6.89 | | | | |
| 4 | A4 | 53.79 | 19.74 | | 9.44 | | | | |
| 5 | A5 | 55.19 | 20.26 | | 7.08 | | | | |
| 6 | A6 | 57.97 | 21.28 | | 2.40 | | | | |
| 7 | A7 | 57.06 | 20.94 | | 3.94 | | | | |
| 8 | A8 | 56.81 | 20.78 | | 4.70 | | | | |
| 9 | A9 | 50.43 | 18.51 | | 15.10 | | | | |
| 10 | A10 | 57.57 | 21.13 | | | | | 3.08 | |
| 11 | A11 | 49.18 | 18.05 | | 8.63 | | | | |
| 12 | A12 | 51.87 | 17.29 | | 3.94 | | | | |
| 13 | A13 | 51.66 | 17.22 | | 4.33 | | | | |
| 14 | A14 | 50.67 | 18.89 | | 6.16 | | | | |
| 15 | A15 | 49.24 | 18.41 | | 8.81 | | | | |
| 16 | A16 | 53.10 | 17.70 | | | | | 1.87 | |
| 17 | A17 | 52.27 | 17.42 | | | 3.20 | | | |
| 18 | A18 | 52.99 | 17.66 | | | | | | |
| 19 | A19 | 53.23 | 17.74 | | | | | | 1.42 |
| 20 | A20 | 52.61 | 17.54 | | 2.56 | | | | |
| 21 | A21 | 50.11 | 16.70 | | 7.21 | | | | |
| 22 | A22 | 50.09 | 16.70 | | 7.24 | | | | |
| 23 | A23 | 50.34 | 16.78 | | 6.79 | | | | |
| 24 | A24 | 50.12 | 16.71 | | 7.18 | | | | |
| 25 | A25 | 51.46 | 17.15 | | 4.70 | | | | |
| 26 | A26 | 50.97 | 16.99 | | 5.62 | | | | |
| 27 | A27 | 51.10 | 17.03 | | 5.37 | | | | |
| 28 | A28 | 51.14 | 17.05 | | 5.30 | | | | |
| 29 | A29 | 50.69 | 16.90 | | 6.13 | | | | |
| 30 | A30 | 50.51 | 16.84 | | 6.47 | | | | |
| 31 | A31 | 51.11 | 17.04 | | 5.35 | | | | |
| 32 | A32 | 48.15 | 16.05 | | 10.83 | | | | |
| 33 | A33 | 50.38 | 16.79 | | 6.70 | | | | |
| 34 | A34 | 49.65 | 16.55 | | 6.05 | | | | |
| 35 | A35 | 51.02 | 17.01 | | 5.51 | | | | |
| 36 | A36 | 55.10 | 20.22 | | 7.24 | | | | |
| 37 | A37 | 49.90 | 16.63 | | 7.59 | | | | |
| 38 | A38 | 51.17 | 17.06 | | 5.24 | | | | |
| 39 | A39 | 54.00 | 18.00 | | | | | | |
| 40 | A40 | 51.50 | 17.17 | | 4.63 | | | | |
| 41 | A41 | 50.18 | 16.73 | | 7.07 | | | | |
| 42 | A42 | 49.67 | 16.62 | | 7.64 | | | | |
| 43 | A43 | 50.79 | 16.93 | | 5.94 | | | | |
| 44 | A44 | 52.59 | 17.53 | | 2.60 | | | | |
| 45 | A45 | 49.59 | 16.53 | | 8.17 | | | | |
| 46 | A46 | 52.10 | 17.37 | | 3.52 | | | | |
| 47 | A47 | 51.58 | 12.41 | 4.77 | 4.52 | | | | |
| 48 | A48 | 50.33 | 16.78 | | 6.80 | | | | |

| | De- | Epoxy | | | | Ceramic |
|---|---|---|---|---|---|---|
| | complexer | Resin | ABS-Rubber | Acrylic Resin | Thixotrope | Canospheres |
| | GA | MY-0510 | BLENDEX 360 | ELVACITE 2010 | AEROSIL 200 | FILLITE 160W |
| Example | (% w/w) | (% w/w) | (% w/w) | (% w/w) | (% w/w) | (% w/w) |
| 1 | | | 10.30 | | 0.86 | 5.16 |
| 2 | | | 10.88 | | 0.90 | 5.42 |
| 3 | | | 11.08 | | 0.92 | 5.52 |
| 4 | | | 10.76 | | 0.90 | 5.37 |
| 5 | | | 11.04 | | 0.92 | 5.51 |
| 6 | | | 11.59 | | 0.97 | 5.79 |
| 7 | | | 11.41 | | 0.95 | 5.70 |
| 8 | | | 11.32 | | 0.94 | 5.65 |
| 9 | | | 10.09 | | 0.84 | 5.03 |
| 10 | | | 11.51 | | 0.96 | 5.75 |
| 11 | | 8.57 | 9.84 | | 0.82 | 4.91 |
| 12 | | | 17.30 | 4.80 | | 4.80 |
| 13 | | | 17.23 | 4.76 | | 4.78 |
| 14 | | | 16.90 | 4.69 | | 4.69 |
| 15 | | | 16.42 | 4.56 | | 4.56 |
| 16 | | | 17.69 | 4.92 | | 4.92 |
| 17 | | | 17.43 | 4.84 | | 4.84 |
| 18 | 1.88 | | 17.67 | 4.91 | | 4.91 |
| 19 | | | 17.75 | 4.93 | | 4.93 |
| 20 | | | 20.47 | 1.95 | | 4.87 |
| 21 | | | 19.48 | 1.86 | | 4.64 |
| 22 | | | 19.47 | 1.86 | | 4.64 |
| 23 | | | 19.57 | 1.86 | | 4.66 |
| 24 | | | 19.49 | 1.86 | | 4.64 |
| 25 | | | 20.02 | 1.91 | | 4.78 |
| 26 | | | 19.81 | 1.89 | | 4.72 |
| 27 | | | 19.88 | 1.89 | | 4.73 |
| 28 | | | 19.89 | 1.89 | | 4.73 |
| 29 | | | 19.71 | 1.88 | | 4.69 |
| 30 | | | 19.63 | 1.87 | | 4.68 |
| 31 | | | 19.88 | 1.89 | | 4.73 |
| 32 | | | 18.73 | 1.78 | | 4.46 |
| 33 | | | 19.59 | 1.87 | | 4.67 |
| 34 | | | 19.31 | 1.84 | | 4.60 |
| 35 | | | 17.01 | 4.72 | | 4.73 |
| 36 | | | 11.02 | | 0.92 | 5.50 |
| 37 | | | 19.41 | 1.85 | | 4.62 |
| 38 | | | 17.06 | 4.74 | | 4.73 |
| 39 | | | 18.00 | 5.00 | | 5.00 |
| 40 | | | 17.17 | 4.77 | | 4.76 |
| 41 | | | 16.73 | 4.65 | | 4.64 |
| 42 | | | 16.62 | 4.62 | | 4.63 |
| 43 | | | 19.75 | 1.88 | | 4.71 |
| 44 | | | 20.45 | 1.95 | | 4.88 |
| 45 | | | 19.28 | 1.84 | | 4.59 |
| 46 | | | 20.36 | 1.83 | | 4.72 |
| 47 | | | 16.14 | 4.77 | | 3.83 |
| 48 | | | 19.57 | 1.86 | | 4.66 |

### Example 4

A series of two-component acrylic adhesives was prepared (see Table 6, AF series), using as Part A composition s A1-A48 (Example 3, Table 5) and as initiator (Part B) the organoborane complexes C1-C22 (Examples 1 & 2,Tables 3 & 4). The components were mixed immediately prior to bonding the substrates. Overlap shear specimens were prepared and tested according to the adhesion test method described here before. Table 6 gives details of the adhesive compositions, the ratios of Part A and Part B, and the tensile shear strength results and failure mode of bonded joints of various substrates.

In one case (No. 43, Table 6), the bonded joint was left to cure for 24 h at 23° C.

In one case (No. 63, Table 6), the bonded joint was left to cure for 1 h at 80° C. After cooling the joint down to ambient temperature, the joint was tested for tensile shear strength (TSS) similarly as all the other joints prepared herein.

TABLE 6

| | | | | | | Adhesion Strength | | |
|---|---|---|---|---|---|---|---|---|
| | Adhesive | | | Part A | Part B | Joint | TSS | |
| No | Formulation | Part A | Part B | (% w/w) | (% w/w) | (substrate—substrate) | (MPa) | Failure mode |
| 1 | AF1 | A1 | C3 | 66.1 | 33.9 | PP—PP | 3.32 | CF |
| 2 | AF2 | A2 | C3 | 74.7 | 25.3 | PP—PP | 3.67 | CF |
| 3 | AF3 | A3 | C3 | 78.7 | 21.3 | PP—PP | 3.31 | CF |
| 4 | AF4 | A11 | C3 | 74.7 | 25.3 | PP—PP | 3.78 | CF |
| 5 | AF5 | A4 | C3 | 72.9 | 27.1 | PP—PP | 3.78 | CF |
| 6 | AF6 | A5 | C3 | 78.2 | 21.8 | PP—PP | 3.17 | CF |
| 7 | AF7 | A6 | C10 | 97.2 | 2.8 | PP—PP | 4.12 | CF |
| 8 | AF8 | A7 | C10 | 95.4 | 4.6 | PP—PP | 5.01 | CF |
| 9 | AF9 | A8 | C10 | 94.6 | 5.4 | PP—PP | 4.91 | CF |
| 10 | AF10 | A9 | C3 | 73.7 | 26.3 | PP—PP | 3.03 | CF |
| 11 | AF11 | A10 | C3 | 73.6 | 26.4 | PP—PP | 3.34 | CF |
| 12 | AF12 | A12 | C20 | 95.6 | 4.4 | PP—PP | 6.56 | SF |
| 13 | AF13 | A12 | C12 | 95.4 | 4.6 | PP—PP | 5.42 | SF |
| 14 | AF14 | A13 | C9 | 94.6 | 5.4 | PP—PP | 3.37 | CF |
| 15 | AF15 | A13 | C10 | 94.6 | 5.4 | PP—PP | 6.76 | SF |
| 16 | AF16 | A13 | C12 | 94.6 | 5.4 | PP—PP | 6.94 | SF |
| 17 | AF17 | A14 | C14 | 94.0 | 6.0 | PP—PP | 3.09 | CF |
| 18 | AF18 | A14 | C23 | 94.0 | 6.0 | PP—PP | 6.56 | SF |
| 19 | AF19 | A16 | C12 | 94.4 | 5.6 | PP—PP | 4.54 | CF |
| 20 | AF20 | A17 | C12 | 94.5 | 5.5 | PP—PP | 4.77 | CF |
| 21 | AF21 | A18 | C12 | 94.4 | 5.6 | PP—PP | 6.36 | SF |
| 22 | AF22 | A19 | C12 | 94.4 | 5.6 | PP—PP | 6.69 | SF |
| 23 | AF23 | A28 | C17 | 90.9 | 9.1 | PP—PP | 4.05 | CF |
| 24 | AF24 | A27 | C15 | 90.9 | 9.1 | PP—PP | 4.63 | CF |
| 25 | AF25 | A26 | C16 | 90.9 | 9.1 | PP—PP | 5.64 | SF |
| 26 | AF26 | A29 | C12 | 93.0 | 7.0 | PP—PP | 6.24 | SF |
| 27 | AF27 | A30 | C9 | 91.8 | 8.2 | PP—PP | 3.47 | CF |
| 28 | AF28 | A31 | C10 | 95.0 | 5.0 | PP—PP | 4.68 | CF |
| 29 | AF29 | A25 | C12 | 94.6 | 5.4 | PP—PP | 5.27 | SF |
| 30 | AF30 | A33 | C3 | 93.9 | 6.9 | PP—PP | 3.27 | CF |
| 31 | AF31 | A34 | C18 | 90.8 | 9.2 | PP—PP | 3.21 | CF |
| 32 | AF32 | A14 | C19 | 90.6 | 9.4 | PP—PP | 3.48 | CF |
| 33 | AF33 | A36 | C4 | 87.8 | 12.2 | PP—PP | 2.54 | CF |
| 34 | AF34 | A24 | C13 | 93.5 | 6.5 | PP—PP | 3.03 | CF |
| 35 | AF35 | A47 | C11 | 94.6 | 5.4 | PP—PP | 1.36 | CF |
| 36 | AF36 | A38 | C11 | 93.8 | 6.2 | PP—PP | 4.89 | CF |
| 37 | AF37 | A43 | C11 | 93.0 | 7.0 | PP—PP | 3.74 | CF |
| 38 | AF38 | A44 | C5 | 94.5 | 5.5 | PP—PP | 6.08 | SF |
| 39 | AF39 | A45 | C5 | 84.5 | 15.5 | PP—PP | 3.80 | CF |
| 40 | AF40 | A46 | C6 | 94.5 | 5.5 | PP—PP | 5.08 | SF |
| 41 | AF41 | A48 | C6 | 89.9 | 10.1 | PP—PP | 2.86 | CF |
| 42 | AF42 | A41 | C21 | 91.5 | 8.5 | PP—PP | 4.52 | CF |
| 43 | AF43 | A35 | C12 | 94.6 | 5.4 | PP—PP | 6.05 | CF |
| 44 | AF44 | A42 | C22 | 91.5 | 8.5 | PP—PP | 5.13 | SF |
| 45 | AF45 | A20 | C8 | 85.1 | 14.9 | CPP—CPP | 3.44 | CF |
| 46 | AF46 | A21 | C12 | 93.1 | 6.9 | CPP—CPP | 2.63 | CF |
| 47 | AF47 | A22 | C9 | 91.9 | 8.1 | CPP—CPP | 4.53 | SN |
| 48 | AF48 | A23 | C10 | 94.7 | 5.3 | CPP—CPP | 4.93 | SN |
| 49 | AF49 | A24 | C13 | 93.5 | 6.5 | CPP—CPP | 2.28 | CF |
| 50 | AF50 | A25 | C12 | 94.6 | 5.4 | CPP—CPP | 4.53 | SN |
| 51 | AF51 | A15 | C3 | 74.3 | 25.7 | CPP—CPP | 2.48 | CF |
| 52 | AF43 | A35 | C12 | 94.6 | 5.4 | PC—PC | 4.30 | SF |
| 53 | AF43 | A35 | C12 | 94.6 | 5.4 | PTFE—PTFE | 3.90 | CF |
| 54 | AF52 | A40 | C12 | 95.4 | 4.6 | PTFE6—PTFE6 | 5.18 | CF |
| 55 | AF53 | A32 | C10 | 94.9 | 5.1 | ABS—ABS | 4.36 | SF |
| 56 | AF53 | A32 | C10 | 94.9 | 5.1 | PVC—PVC | 4.03 | SF |
| 57 | AF54 | A37 | C9 | 91.5 | 8.5 | PMMA—PMMA | 3.81 | SF |
| 58 | AF43 | A35 | C12 | 94.6 | 5.4 | LDPE—LDPE | 2.04 | SN |
| 59 | AF43 | A35 | C12 | 94.6 | 5.4 | HDPE—HDPE | 5.02 | SN |
| 60 | AF43 | A35 | C12 | 94.6 | 5.4 | AL—AL | 12.11 | CF |
| 61 | AF43 | A35 | C12 | 94.6 | 5.4 | STL—STL | 13.62 | CF |
| 62 | AF43 | A35 | C12 | 94.6 | 5.4 | STL-PP | 8.01 | SF |
| 63 | AF55 | A39 | C12 | 94.4 | 5.6 | PP—PP | 3.32 | AF |

### Example 5

Table 7, presents data regarding typical strength build-up (tensile shear strength vs. curing time @ 23° C. for PP-joints) of the adhesive formulation AF43 prepared in Example 4 (Table 6) and for a competitor's product (CROP). The curing time for both adhesives was: 0.5, 1, 2, 4, 6 and 24 h). AF43 develops handling strength (0.4 MPa) in about 1 h and maximum strength (substrate failure) in about 7-10 h. It becomes evident that this particular formulation outperforms the competitor's product (CROP) as it develops strength faster (handling strength achieved after only 1 h whilst the corresponding figure for the CROP was 2 h).

TABLE 7

| | AF43 | | | CORP | | |
|---|---|---|---|---|---|---|
| Curing time | TSS | | | TSS | | |
| (h) | (MPa) | % Max. strength* | Failure mode | (MPa) | % Max. strength* | Failure mode |
| 0.5 | 0.29 | 4.79 | AF | 0.12 | 2.02 | AF |
| 1 | 0.45 | 7.44 | AF | 0.23 | 3.87 | AF |
| 2 | 1.65 | 27.27 | CF | 0.40 | 6.73 | AF |
| 4 | 3.68 | 60.83 | CF | 1.70 | 28.61 | CF |
| 6 | 4.59 | 75.87 | CF | 3.94 | 66.31 | CF |
| 24 | 6.05 | 100.00 | SF | 5.94 | 100.00 | SF |

*the % max. strength for each of the adhesives of the Table is equal to: TSS recorded upon certain curing time multiplied by 16.53 in the case of AF43 or by 16.83 in the case of CROP).

### Example 6

When PP-PP joints were prepared with the adhesive formulation AF43 (A35 as part A and C12 as part B) [see Example 4 (Table 6), and tested at elevated temperatures 60, 90 and 120° C., afforded in all cases cohesive failure at tensile shear strengths (TSS) 2.32, 0.67 and 0.71 MPa, respectively.

### Example 7

Studies on “open” time of plastic adhesives—Introduction of styrenic compounds in formulations containing aldehydes

A13 was used as the reference adhesive formulation for studying the open time extension using styrenic compounds. In the following series of experiments 4-MethylStyrene was used as an open time extender at a weight percentage of 3.8 and 1.9% on adhesive mixture that ensures open times longer than 18 min (hand mixing). All overlap PP-joints were formed upon mixing and coating both sides of the joint substrates (immediate assembly: no elapsed time).

4-MS: 1.9% w/w on adhesive mixture

| Composition | 1 | 2 | 3 | 4 | 5 | 6 | 7 |
|---|---|---|---|---|---|---|---|
| A13 | 0.5000 | 0.5000 | 0.5000 | 0.5000 | 0.5000 | 0.5000 | 0.5000 |
| 4-MS | 0.0200 | 0.0200 | 0.0200 | 0.0200 | 0.0200 | 0.0200 | 0.0200 |
| complex KBM-903C | 0.0300 | 0.0300 | 0.0300 | 0.0300 | 0.0300 | 0.0300 | 0.0300 |
| terephthaloyl dicarbaxaldehyde | 0.0089 | 0.0089 | 0.0089 | 0.0089 | 0.0089 | 0.0089 | 0.0089 |
| Total weight | 0.559 | 0.559 | 0.559 | 0.559 | 0.559 | 0.559 | 0.559 |
| Ratio: mol decomplexer/1 mol of | 0.50 | 0.50 | 0.50 | 0.50 | 0.50 | 0.50 | 0.50 |
| complex | | | | | | | |
| Curing @ RT | 15 min | 30 min | 1 h | 2 h | 4 h | 6 h | 24 h |
| Lap shear strength (MPa) | 0.01 | 0.02 | 0.02 | 0.04 | 0.44 | 1.09 | 6.72 |
| Failure type | not | not | not | CF | CF | CF | SF |
| | cured | cured | cured | | | | |

This example shows clearly the balance of properties that can be achieved by incorporating the aldehyde and styrenic compounds.

1-22. (canceled)

23. A complex of (i) an organoboron compound of the general formula (I):
B(R¹)₃ (I)
in which each R¹ independently represents an alkyl group, an aryl group, an alkylaryl group, an arylalkyl group, a cycloalkyl group, an alkylcycloalkyl group or a cycloalkylalkyl group each of which may be unsubstituted or substituted by one or more of the same or different substituents selected from halogen atoms and alkoxy groups
and (ii) an organosilicon compound containing at least one primary, secondary and/or tertiary amino group.

24. The complex as claimed in claim 23, in which each R¹ independently represents a C₁₋₁₀ alkyl group.

25. The complex as claimed in claim 24, wherein each R¹ is independently selected from the group consisting of an ethyl group, isopropyl group, t-butyl group and n-butyl group.

26. The complex as claimed in claim 23, in which the organosilicon compound has the general formula (II): 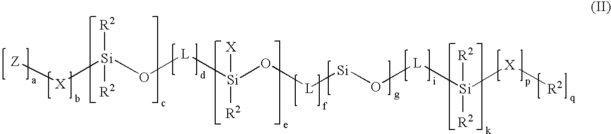
in which:
a and q, are independently equal to 0 or 1;
b, c, d, e, f, g, i, k, and p are independently equal to or greater than 0 and wherein a, c, e, g, and k cannot be all equal to 0 at the same time and at least one of b, d, f, i and p is equal to or greater than 1;
each R² independently represents a hydrogen atom, a hydroxyl group, an alkyl group, a fluoroalkyl group, a glycidyl alkyl group, an acrylalkyl group, a (meth)acrylalkyl group, an alkoxy group, an alkoxyalkyl group, an alkenyl group, a cycloalkyl group, an aryl group, an alkyloxyaryl group, an aryloxyalkyl group or an alkyloxycycloalkyl group, each of which may be optionally substituted by one or more primary, secondary or tertiary amino groups, hydroxyl groups or carbonyl groups;
each X, when b, p or e is equal to 1, independently represents a group of the general formulae: 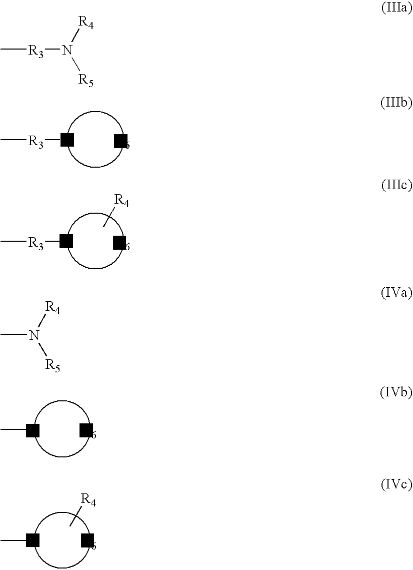
in which:
R³ represents an alkylene group, an alkenyl group, a phenylene group or a cycloalkylene group; each of R⁴ and R⁵ independently represents a hydrogen atom, a hydroxyl group, an alkyl group, an aryl group, a silylalkyl group, a silylaryl group, a cycloalkyl group, an arylalkyl group, an alkylaryl group, a cycloalkylalkyl group, an alkylcycloalkyl group, a saturated or unsaturated eterocyclic group, a phenyl (Ph-) group, a phenoxy (Ph—O—) group, a Ph-(C═O)— group, a fluoroalkyl group, a glycidyl alkyl group, an acrylalkyl group, a (meth)acrylalkyl group, an alkoxy group, an alkoxyalkyl group, an alkenyl group, an alkyloxyaryl group, an aryloxyalkyl group or an alkyloxycycloalkyl group each of which may be optionally substituted by one or more primary, secondary or tertiary amino groups, hydroxyl groups, or carbonyl groups; R⁶ represents an alicyclic group, aromatic group or saturated or unsaturated eterocyclic group each of which can be mono-, di-, tri-, tetra-, or penta-substituted by R³ or R⁴ groups;
and each X, when b, e or p is greater than 1, independently represents a group of the formulae: 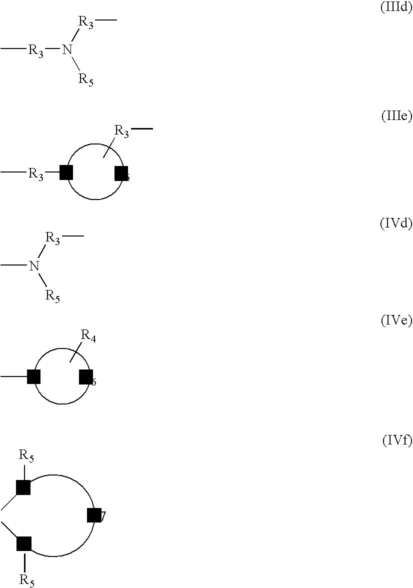
in which:
R³, R⁴, R⁵ and R⁶ are as defined above;
R⁷ represents a cyclic of the structure —Si(R²)—[Si(R²)₂—NH—],—Si(R²)— where n is equal to or greater than 1 and R² is defined as above;
L represents a monovalent or divalent group independently selected from any of the groups representing X, R², R³, R⁵, R⁴, R⁶, R⁷ or a polymeric/oligomeric organic mono- or di-radical; and
Z represents: 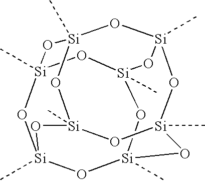
wherein every silicon atom forms a bond with either X or R² or R⁴ or R⁵ and wherein at least one of the silicon atoms is bonded with one X.

27. The complex as claimed in claim 26, in which b=1, c=1 and q=1 and a, d, e, f, g, i, k, p and q are equal to 0.

28. The complex as claimed in claim 26, in which b=1, c is greater than 1, e is greater than 1, k=1 and p=1 and a, d, f, g, i and q are equal to 0.

29. The complex as claimed in claim 26, in which a=1 and b=1 and c, d, e, f, g, i, k, p and q are equal to 0.

30. The complex as claimed in claim 26, in which the organosilicon compound is 3-(2-aminoethylamino)propyltrimethoxy silane; 3-(2-aminoethylamino)propyltriethoxy silane; (aminopropyl)trimethoxy silane; (aminopropyl)triethoxy silane; (aminomethyl)trimethoxy silane; (aminomethyl)triethoxy silane; (N-cyclohexylaminomethyl)trimethoxy silane; (N-cyclohexylaminomethyl)triethoxy silane; (N-phenylaminomethyl)trimethoxysilane; (N-phenylaminomethyl)methyldimethoxysilane; (N,N-dimethylaminopropyl)trimethoxysilane; Bis[(3-trimethoxysilyl)propyl]ethylenediamine; N-(3-triethoxysilylpropyl)4,5-dihydroimidazole; 2-(trimethoxysilylethyl)pyridine; Bis(p-aminophenoxy)dimethylsilane; Bis(p-aminophenoxy)dimethylsilane; Bis(dimethylamino)diethylsilane; Ureidopropyltrimethoxysilane; Bis(N-methylbenzamido)ethoxymethylsilane; Octamethylcyclotetrasilazane; 1,3-Bis(3-aminopropyl)tetramethyldisiloxane; an amino functionalized silicone fluid; an amino functionalized silica gel; an amino functionalized-POSS; an amino/imino functionalized POSS, or mixtures thereof.

31. The complex as claimed in claim 26, in which the organosilicon compound is hydroxyethoxysilatrane.

32. A method of initiating the polymerization of a polymerizable monomer or oligomer by contacting the monomer or oligomer with a complex of (i) an organoboron compound of the general formula (I):
B(R¹)₃ (I)
in which each R¹ independently represents an alkyl group, an aryl group, an alkylaryl group, an arylalkyl group, a cycloalkyl group, an alkylcycloalkyl group or a cycloalkylalkyl group each of which may be unsubstituted or substituted by one or more of the same or different substituents selected from halogen atoms and alkoxy groups
and (ii) an organosilicon compound containing at least one primary, secondary and/or tertiary amino group and optionally supplying energy in the form heat, actinic radiation, electromagnetic radiation, magnetic radiation, electrical current, ultrasound, ultraviolet radiation or combinations thereof sufficient to release the boron compound from the complex.

33. A method of adhesively bonding two substrates together comprising the steps of applying a polymerizable composition comprising a polymerizable monomer or oligomer and a complex of (i) an organoboron compound of the general formula (I):
B(R¹)₃ (I)
in which each R¹ independently represents an alkyl group, an aryl group, an alkylaryl group, an arylalkyl group, a cycloalkyl group, an alkylcycloalkyl group or a cycloalkylalkyl group each of which may be unsubstituted or substituted by one or more of the same or different substituents selected from halogen atoms and alkoxy groups
and (ii) an organosilicon compound containing at least one primary, secondary and/or tertiary amino group to a first substrate; positioning a second substrate in contact with the first substrate; and curing the polymerizable composition.

34. The method of claim 33, wherein at least one of the substrates is a low surface energy substrate.

35. The method of claim 34, wherein the low surface energy substrate comprises a material selected from polyethylene, polypropylene, copolymers of a-olefins, and fluorinated polymers.

36. The method of claim 33, wherein the surface of at least one of the substrates comprises a material selected from the group of thermoplastics, thermosets, wood, composites, ceramics, glass, concrete, and metals.

37. A polymerisable composition comprising at least one radically polymerisable monomer and/or oligomer and a complex of (i) an organoboron compound of the general formula (I):
B(R¹)₃ (I)
in which each R¹ independently represents an alkyl group, an aryl group, an alkylaryl group, an arylalkyl group, a cycloalkyl group, an alkylcycloalkyl group or a cycloalkylalkyl group each of which may be unsubstituted or substituted by one or more of the same or different substituents selected from halogen atoms and alkoxy groups
and (ii) an organosilicon compound containing at least one primary, secondary and/or tertiary amino group.

38. The polymerisable composition of claim 37, which further comprises at least one of a reactive or non-reactive diluent, a decomplexing agent and an open time extender.

39. The polymerisable composition of claim 37, which further comprises one or more fillers.

40. The polymerisable composition of claim 37 which further comprises trimethylolpropane tris(2-methyl-1-aziridinepropionate).

41. The polymerisable composition of claim 37 which further comprises at least one heat management material.

42. The polymerisable composition of claim 37, in which the concentration of the complex is sufficient to provide 0.001% to 10.0% by weight of boron, based on the total weight of the polymerisable composition.

43. A 2 part composition comprising:
(1) a silicon-amino organo-borane complex comprising an organoboron compound of the general formula (I):
B(R¹)₃ (I)
in which each R¹ independently represents an alkyl group, an aryl group, an alkylaryl group, an arylalkyl group, a cycloalkyl group, an alkylcycloalkyl group or a cycloalkylalkyl group each of which may be unsubstituted or substituted by one or more of the same or different substituents selected from halogen atoms and alkoxy groups
and an organosilicon compound containing at least one primary, secondary and/or tertiary amino group; and
(2) a blend of radically polymerisable compounds, at least one decomplexing agent; and optionally at least one open time extender and/or toughener material.
